(19) United States
(12) Patent Application Publication
(10) Pub. No.: US 2009/0070949 A1
(43) Pub. Date: Mar. 19, 2009

(54) Oral Care Compositions, Methods, Devices and Systems

(75) Inventors: Paul Albert Sagel, Maineville, OH (US); Marc Philip Ortins, Reading, MA (US); Vadim Denishenko, Newton, MA (US); Phillip Maurice Braun, Exeter, RI (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: THE GILLETTE COMPANY, Cincinnati, OH (US)

(21) Appl. No.: 12/125,199

(22) Filed: May 22, 2008

(30) Foreign Application Priority Data
May 31, 2007 (WO) US2007/012901

(51) Int. Cl. A46B 13/04; A46B 9/04; A61C 15/00

(52) U.S. Cl. 15/28; 15/167.1; 433/216

(57) ABSTRACT

Oral care treatments are provided, including multi-component oral care compositions and methods for delivering such compositions to the oral cavity. Oral care devices and systems for implementing such oral care treatments are also provided.

### TECHNICAL FIELD

This invention relates to oral care compositions, methods, devices, and systems.

### BACKGROUND

While the use of two or more oral care compositions is known, there is a desire to provide improved products and methods for delivering one or more compositions to the oral cavity.

### SUMMARY

In general, the invention features oral care treatments, including multi-component oral care compositions, methods of oral care, including protocols for the delivery of multiple components to the oral cavity, and oral care devices, kits, and systems.

### DESCRIPTION OF DRAWINGS

FIG. 1 is a side perspective view of an embodiment of an oral care system.

FIG. 2A is a front perspective view of an embodiment of an oral care device.

FIG. 2B is a rear perspective view of the oral care device of FIG. 2A.

FIG. 3A is a transparent front view of the oral care device of FIG. 2A.

FIG. 3B is a transparent rear view of the oral care device of FIG. 2A.

FIGS. 4A and 4B are rear and front views, respectively, of the head and neck of another oral care device embodiment with the neck shown as transparent.

FIG. 5 is a rear view of the head and neck of another oral care device embodiment with the neck shown as transparent.

FIGS. 6 and 7 are front perspective views of two brush embodiments.

FIG. 8A is a side perspective view of an embodiment of a docking station.

FIG. 8B is a transparent side perspective view of the docking station of FIG. 8A.

FIG. 9 illustrates a docking station embodiment.

FIG. 10 illustrates another docking station embodiment.

FIG. 11 is a perspective view of an embodiment of an oral care system.

FIG. 12 is a perspective view of base portion B of the docking station shown in FIG. 11.

FIG. 13 is a cross-sectional view of a dual compartmented dispenser suitable for use with the present invention.

FIG. 14 is a cross-sectional view of two dispensers suitable for use with the present invention.

FIG. 15 is a front view of a dispensing toothbrush suitable for use with the present invention.

FIG. 16 is a schematic representation of an oral care system in accordance with the present invention.

FIG. 17 is a schematic representation of electrical components suitable for use with the present invention.

### DETAILED DESCRIPTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, dosage, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Generally, oral care treatments involving delivery of two or more oral care compositions, parts of a composition, materials, formulations, or ingredients (referred to collectively below as “components”) to the oral cavity will be discussed below. Particularly, two components mechanically separated from each other prior to delivery will be discussed below. The components can be delivered from a variety of oral care devices, such as a manual toothbrush, an electric toothbrush, a package, or dispenser. The components can be delivered simultaneously or sequentially. In some cases, the two components, when mixed together, during delivery or in the oral cavity, react or otherwise interact together to form an oral care composition, for example the dual component dentifrices described in U.S. Pat. No. 6,375,933 and discussed below in the Oral Care Compositions and Components section. In other cases, the components themselves are complete oral care compositions; for example a component may be a dentifrice or a mouthwash. We will first discuss various oral care treatments that can be performed. Next, we will discuss examples of devices that are suitable for delivering the components. Finally, we will discuss examples of various components that can be delivered. The components may be in any form that can be delivered by the desired delivery device, e.g., a Newtonian or non-Newtonian fluid, a liquid, a paste or a gel.

Methods of Use

In the following discussion, we will refer to delivery of two mechanically separated components. However, it will be apparent that the methods discussed could be extended to three or more components. The methods described below may be performed, for example, using a dispensing device having a microprocessor controller. In a toothbrush, a stationary or moving head (or moving portions of the head) may be used. For example, suitable toothbrushes having heads (or portions the head, including bristles or elements) which rotate, oscillate, reciprocate, translate, vibrate, etc., as described in U.S. application Ser. Nos. 09/993,167; 10/036,613; 10/114,870; 10/128,018; 10/208,213; and 10/830,693; and U.S. Pat. No. 5,378,153. Additionally toothbrushes having light emitting diodes may be used, including toothbrushes which emit light (including blue light), as described in U.S. application Ser. Nos. 10/832,168; 10/847,429; 10/842,302; 10/887,644; 10/887,667; and 10/888,206. Suitable toothbrushes may or may not comprise bristles or cleaning elements. In another embodiment, dispensers, such as a multi-compartmented package, can be used with the present invention as discussed further below. Examples of suitable devices will be discussed in detail in the Oral Care Devices section, below.

The components can be delivered to the oral cavity simultaneously or sequentially. In the case of sequential delivery, both components may be delivered during a single oral care session, e.g., a single brushing session or other single treatment session (single use, start to finish, by a particular user, typically about 0.1 to 5 minutes), or alternatively the components may be delivered individually over multiple oral care sessions. Many combinations are possible, for example delivery of both components during a first oral care session and delivery of only one of the components during a second oral care session. Examples of possible delivery sequences and regimens are discussed below.

Simultaneous Delivery

The simplest case is simultaneous, continuous delivery of equal amounts of the two components or a constant ratio of the components during a single oral care session. In some instances, for example when one of the components is a liquid such as a rinse, the ratio can be between about 1:20 and about 20:1. The regimens of the present invention may be suitable, for example, when it is desired to deliver two components which do not react with one another, but are incompatible formulation-wise. For example, it may be desirable to deliver two components which require different pH levels to be active, such as stannous pyrophosphate (which is active at low pH) and sodium fluoride (which is active at high pH). The two components may be provided separately, with binder systems having different pH levels, and then delivered simultaneously to the oral cavity. Brushing duration is sufficiently short so that the components will not be inactivated. Another use for simultaneous, continuous delivery is systems that include two components that react relatively slowly, and that will remain in the oral cavity after brushing to be absorbed by the teeth and or gums.

Alternatively, delivery can be simultaneous and continuous, but the ratio of the two components can be varied during brushing. In some cases it may be desirable to initially deliver a relatively large bolus of a first component with a smaller amount of a second component (e.g., an 80:20 ratio or between about 1:20 and about 20:1), and then during brushing reduce the amount of the first component and increase the amount of the second component, for example until the ratio is reversed (e.g., a 20:80 ratio). The change in the relative amounts can be linear, or can be non-linear, e.g., a large burst of toothpaste initially, to have enough paste to begin brushing, with a small amount of mouthwash, followed almost immediately by a significantly reduced amount of paste and increased amount of mouthwash. The components and their ratios can also be selected to provide the user with a brushing experience that goes from initially soothing to an intensely clean/refreshing mouthfeel.

Additionally, two components may be simultaneously delivered during different periods of a single oral care session (e.g., during the seconds 1-5 and seconds 60-65 of a 120 second oral care session) or two components may be simultaneously delivered during different sessions (e.g., every other session).

Sequential Delivery—Single Oral Care Session

Sequential delivery during a single oral care session may take various forms. In one case, two components are delivered in alternation, as either a few relatively long duration cycles during brushing (A B A B), or many rapid-fire alternations (A B A B A B A B A B . . . A B). Examples of treatments that lend themselves well to this type of delivery are remineralization, and treatment with a peroxide and an activator for the peroxide. The preferred cycle time will depend on the chemistry used, and may be optimized for a given chemical reaction. For example, in the case of a peroxide and activator, the cycle time may be relatively long, e.g., 15 seconds, to allow the peroxide and activator to react. Other chemistries, e.g., remineralization systems such as those discussed herein (see the Compositions section below) may be used with faster cycle times, for example 5 seconds or less.

In another case, two or more components are delivered one after the other during a single oral care session, with no subsequent alternating delivery in that oral care session (A followed by B). For example, a dentifrice may be delivered initially, to initiate brushing and provide cleansing, followed by a mouthrinse, fluoride treatment, or temporary sealant. Other options include a peroxide followed by an activator or a dentifrice to enhance fluoridation; a copper dentifrice followed by chlorite; an anti-gingivitis treatment followed by anti-inflammatory treatment; or a pair of components having different flavors, to provide a sensory signal to the user. The flavor change may indicate, for example, that the user should brush longer or can terminate brushing, or that the user should change the mode of brushing, e.g., to a higher or lower brush speed.

Sequential Delivery—Multiple Oral Care Sessions

Other sequential treatment regimens involve multiple oral care sessions. In some implementations, the delivery device includes a clock function, and is programmed to deliver a predetermined treatment at a predetermined time of day or range of times. Different components, different ratios, or a different sequence of components may be delivered, depending on the time of day. For example, one component may be delivered in the morning, and a second, different component may be delivered in the evening, e.g., two different dentifrices or a mouthwash and dentifrice. As another example, two components, e.g., a dentifrice and a mouthrinse, may be delivered in the morning, and dentifrice only may be delivered in the evening. This clock-based approach could allow the user to have two different sensory experiences, to receive two different active ingredients, or to receive an active ingredient only once a day (morning or evening only) while brushing twice a day.

Similarly, some treatment regimens may involve delivery of a specialized treatment, for example a prescription medicine, according to a prescribed treatment protocol, e.g., morning or evening only, every other day (morning and/or evening), or once per week (morning and/or evening). The delivery device can be programmed to deliver the precise dosage at a desired time during brushing. Toothpaste may be delivered at other times, and, if desired, may be delivered simultaneously with the specialized treatment. The specialized treatment may be a prescription toothpaste, with standard over-the-counter toothpaste being dispensed in between prescribed uses of the prescription toothpaste.

Another approach that is useful over multiple oral care sessions is a “counting” feature, whereby the delivery device is programmed to deliver one of the components every x number of oral care sessions. For example, if multiple users utilize the same toothbrush handle, the delivery device may be programmed to recognize a particular user's replaceable toothbrush head, e.g., by RFID, and count only the sessions of that user.

In some cases it may be desirable to program the delivery device to include both a clock feature and a volume-monitoring feature that accumulates data over multiple oral care sessions, for example so that only a predetermined volume of one or both of the components is delivered within a given time period (e.g., less than x grams of component A over a 24 hour period). The volume-monitoring feature may also be used to meter a precise dosage of a component over a single oral care session. Volume-monitoring is desirable, for example, when a component raises toxicity or other safety concerns at higher than normal dosages. For instance, in the case of fluoride treatments for children it is important that the child not receive too much fluoride, due to the risk of fluorosis. The dosage delivered can be measured by any suitable method, such as by accurately calibrating the device and then calculating the dosage indirectly based on the number of pumping cycles. In some cases, the delivery device may be used to precisely control the dosage of a particular active, while allowing a second composition, such as a standard dentifrice, to be delivered as needed.

The delivery device may be programmed to accumulate data regarding brushing time and/or the amount of each component dispensed, for example to allow the user and/or the user's dentist or other clinician to track the user's compliance with a prescribed treatment protocol. This information can be displayed on an LCD display on the delivery device.

When the delivery device (e.g., a power toothbrush) is used by multiple users, the device can be programmed to allow each user to select a desired component for use during that user's oral care session. For example, different users may prefer different flavors of toothpaste, or may require toothpastes with particular performance attributes such as whitening vs. sensitivity reduction.

In the case of a toothbrush, it may be configured so that the two components are delivered to different toothbrush heads. When a first head (e.g., a standard power toothbrush head) is in place, a first component is delivered, e.g., a dentifrice, while when a second head is in place (e.g., a pic, tongue scrape, or gingival brush) another component is delivered, e.g., a mouthrinse. The toothbrush may be configured to automatically recognize the different heads, e.g., by RFID identification or by mechanical means such as a pin setting. Oral care devices having RFID identification of various heads are described in published U.S. Application No. 2002/0129454, the full disclosure of which is incorporated herein by reference.

Delivery Parameters

Delivery according to any of the treatment regimens discussed herein may be intermittent, i.e., with pauses during which no delivery will occur. It is noted that even “continuous” delivery may be intermittent in the sense that the pumping mechanism of the delivery device may operate in a pulsing manner. However, additional and/or longer pauses may be included in the treatment regimen by programming the delivery device accordingly.

About 0.05, 0.1, 0.15, 0.2, 0.25, 0.3, 0.4, 0.5, 0.6, 0.7, 0.8, 0.9, 1, 1.2, 1.4, 1.5, 1.6, 1.8, or 2 grams (or about 0.05, 0.1, 0.15, 0.2, 0.25, 0.3, 0.4, 0.5, 0.6, 0.7, 0.8, 0.9, 1, 1.2, 1.4, 1.5, 1.6, 1.8, 2, 5, 7, 10, 12, 15, 20, 25, or 30 mls) of a first component may be dispensed over a period of about 0.2, 0.4, 0.6, 0.8, 1, 1.2, 1.5, 1.8, 2, 4, 6, 8, 10, 15, 30, 60, 90, or 120 seconds and about 0.05, 0.1, 0.15, 0.2, 0.25, 0.3, 0.4, 0.5, 0.6, 0.7, 0.8, 0.9, 1, 1.2, 1.4, 1.5, 1.6, 1.8, or 2 grams (or about 0.05, 0.1, 0.15, 0.2, 0.25, 0.3, 0.4, 0.5, 0.6, 0.7, 0.8, 0.9, 1, 1.2, 1.4, 1.5, 1.6, 1.8, 2, 5, 7, 10, 12, 15, 20, 25, or 30 mls) of a second component may be dispensed over a period of about 0.2, 0.4, 0.6, 0.8, 1, 1.2, 1.5, 1.8, 2, 4, 6, 8, 10, 15, 30, 60, 90, 120, 180, 240, or 300 seconds from any delivery device. In the case of delivery device that is manually pumped (e.g., the dual compartmented dispenser shown in FIG. 13), the first and/or second component may be dispensed by about 1, 2, 3, 4 or 10 or more actuations of the pump. Also, a first and second component may be dispensed in ratios (first component/second component) of about 90/10, 80/20, 70/30, 60/40, 50/50, 40/60, 30/70, 20/80, or 10/90. Other ratios can be between about 1:20 and about 20:1.

As discussed above, the first and second components may be dispensed simultaneously or sequentially (such that the second component may be dispensed about 0.2, 0.4, 0.6, 0.8, 1, 1.2, 1.5, 1.8, 2, 4, 6, 8, 10, 15, 20, 25, 30, 35, 40, 45, 50, 55, 60, 75, 90, 105, or 120, seconds after the first component). Also, the second component may be dispensed during a second brushing session, following a first brushing session, wherein at least about 4, 6, 8, 10, or 12 hours separate the beginning of the second brushing session from the end of the first brushing session. Also, the second component can be dispensed during the same oral care regimen but after a time interval has lapsed between use of the first component and use of the second component. For instance, a dentifrice (the first component) might be used for 2 minutes and a rinse (the second component) might be applied several seconds or minutes after completing use of the dentifrice.

During a brushing session, there may be several sequences which include various combinations of the above mentioned weights, volumes, and times. The sequences may be simultaneous or sequential, and may include pauses as discussed above. For example, within a 2 minute brushing session, a first sequence may include a volume of a first component and a volume of a second component being dispensed simultaneously, then a second sequence may include a volume of a first component being dispensed, then a period of time without dispensing may occur, then a third sequence may include a volume of the second component being dispensed, then a period of time without dispensing may occur, then a fourth sequence may include a volume of the first component being dispensed.

Delivery Devices

A wide variety of oral care devices can be used to dispense the components of the present invention, including manual toothbrush, electric toothbrushes, and a variety of other packages (e.g., hand pumps, etc.) and devices. First, we will discuss an oral care device that is capable of delivering two components simultaneously.

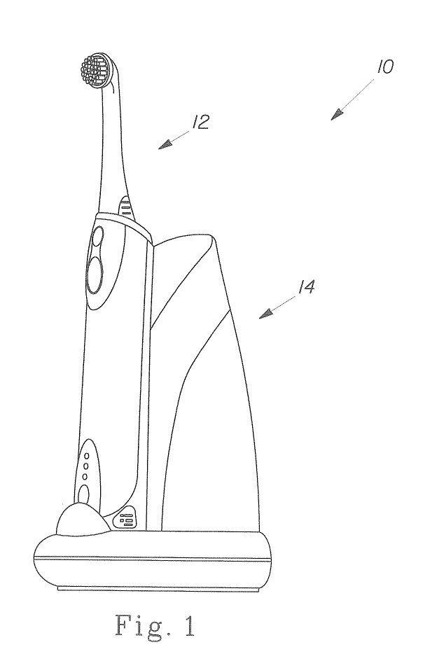

Referring to FIG. 1, an embodiment of an oral care system 10 is shown that includes an oral care device 12, in this case a toothbrush, and a docking station 14 that holds the oral care device 12 in an upright position within a receiving portion of the docking station. Oral care device 12 is a power toothbrush having a motorized head, and is designed to discharge two components, such as a dentifrice and a mouthwash, during the brushing cycle. The docking station 14 is designed to recharge batteries that are located within the oral care device, and to refill the oral care device with the components.

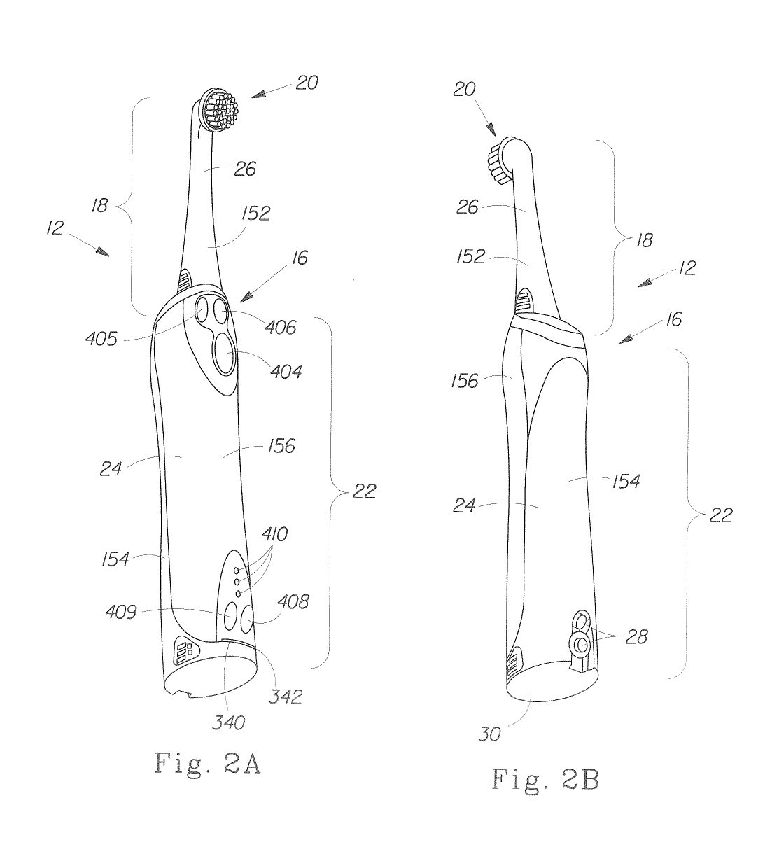

Turning to FIGS. 2A and 2B, oral care device 12 includes a separable housing 16 consisting of three interconnected components 152, 154 and 156. As assembled, the oral care device 12 includes a distal portion 18 at which a head 20 is located and a proximal portion 22 at which a handle 24 is located. Connecting handle 24 and head 20 is neck 26. Head 20 is sized to fit within a user's mouth for brushing, while the handle 24 is graspable by a user and facilitates manipulation of the head 20 during use.

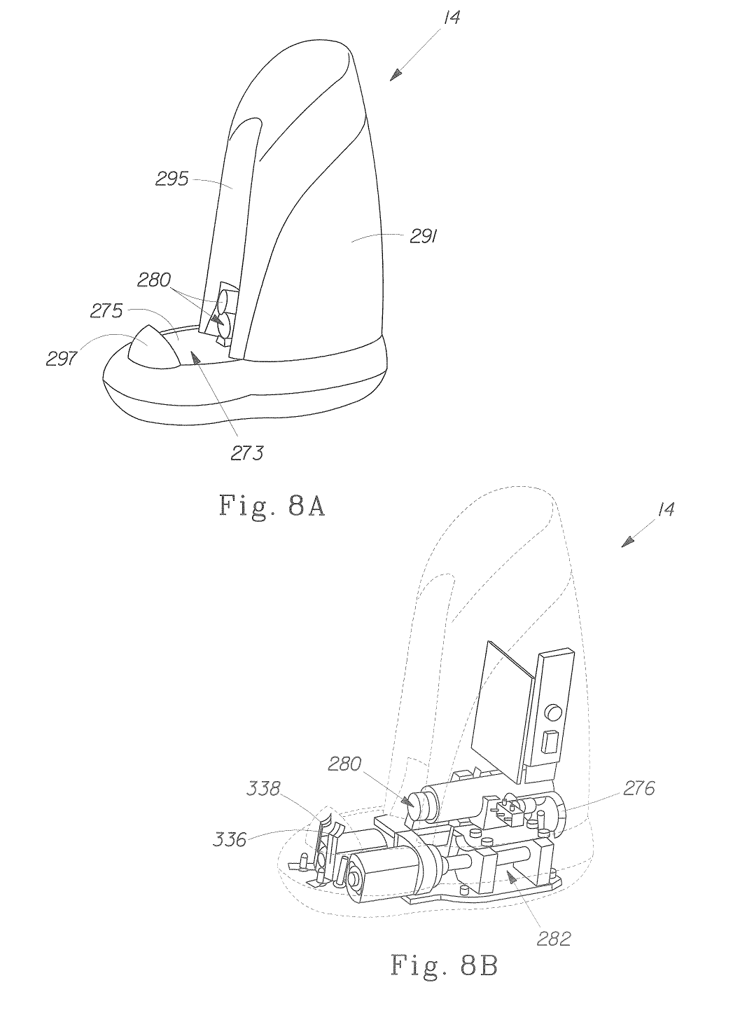

Referring to FIG. 2B, showing a rear view of the oral care device 12, inlets 28 are positioned near an end surface 30 at the proximal portion 22 of the oral care device. The inlets 28 are matable with corresponding outlets 280 (FIG. 8A) located at the docking station 14 for refilling the oral care device.

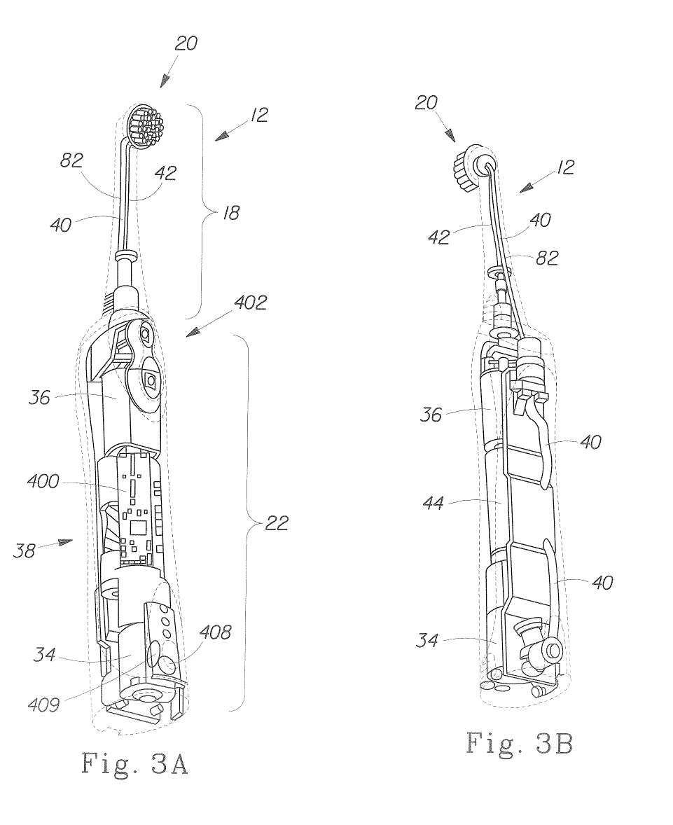

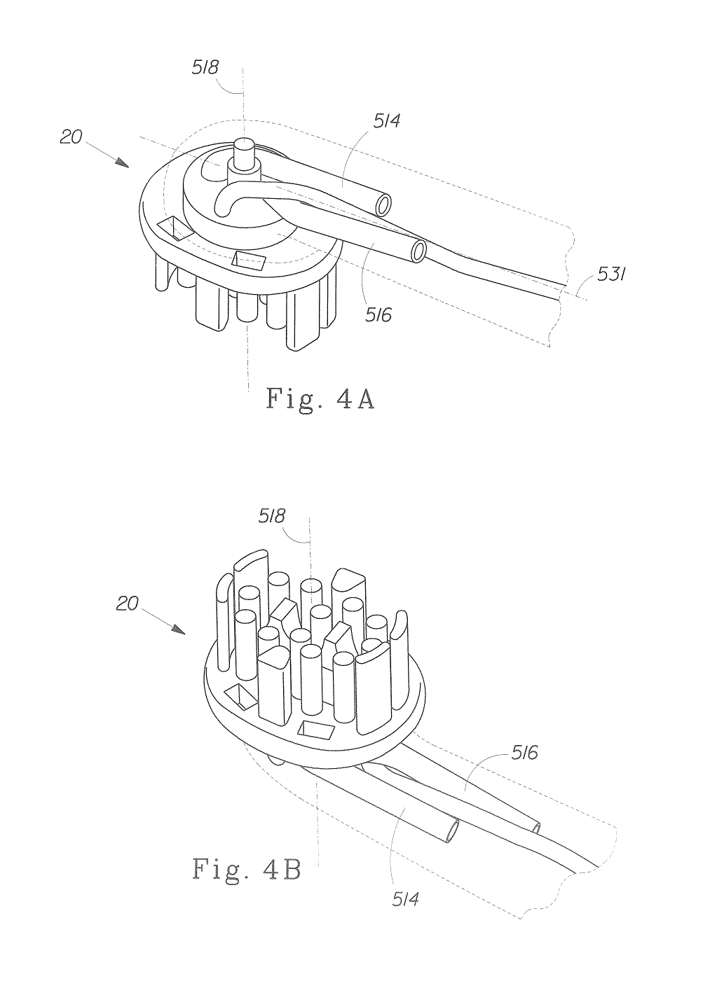

Referring now to FIGS. 3A and 3B, internal components of the oral care device 12 are shown. Oral care device 12 includes motors 34 and 36. Motor 34 drives a pumping assembly 38 that transfers a pair of components along respective passageways (only one of which, passageway 40, is visible in FIGS. 3A and 3B) toward the distal portion 18 of the oral care device 12. The pumping assembly 38 may transfer each component through the respective passageway by compressing a portion of tubes 514 and 516 (FIG. 4A) with a compression element, as described in U.S. Ser. No. 10/861,253, the full disclosure of which is incorporated herein by reference. When an array of fingers is used to compress the tubes progressively, as in the pump assembly described in U.S. Ser. No. 10/861,253, the fingers are dimensioned so that they extend across the width of the two tubes and thus can compress the tubes simultaneously.

Motor 36 drives a drive shaft 42, which in turn moves (e.g., rotates) the head 20. To supply power to motors 34, 36 and 37, a rechargeable battery 44 is electrically coupled to the motors. A suitable rechargeable battery is a Li Ion UR 14500P, available from Sanyo.

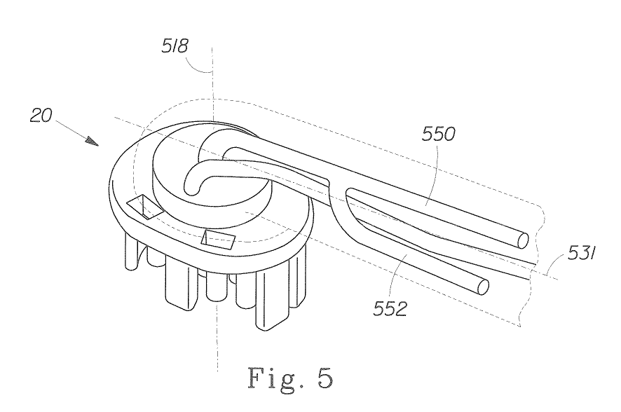

Referring to FIGS. 4A and 4B, the oral care device includes a pair of tubes 514 and 516 to direct the two fluid streams within the oral care device. As shown, each of the tubes 514 and 516 is connected to the head at a location offset from a longitudinal axis 531 perpendicular to an axis of rotation 518 of the movable head 20. In some embodiments, one of the tubes may be connected to the head at the axis of rotation and the other connected at a location offset from the axis of rotation. Referring to FIG. 5, a variation is shown where tubes 550 and 552 are fluidly connected to each other downstream of the pumping assembly and upstream of a fluid outlet at the head. This embodiment may be advantageous where it is desirable to mix the components within the passageways at a time just prior to delivery to a brushing surface.

We note that in FIGS. 3A-3B, only a single passageway 40 is shown, for clarity due to the scale of these drawings. Generally the oral care device 12 includes two passageways, as discussed above (e.g., the tubes 514 and 516 in FIGS. 4A and 4B). However, in some cases a single passageway may be used, for example where the two components can mix upstream of the head, close to separate chambers in which the two components are stored.

Referring back to FIG. 3A, the oral care device 12 includes a control circuit or controller 400 that is electrically connected to the motors 34 and 36, and that generally governs operation of the motors. A user interface 402 provides external interaction with controller 400. The user interface 402 includes on and off buttons 404 and 406 and a fluid level switch 408, all of which are accessible from exterior of the housing 16 (see FIG. 2A).

While the controller can be programmed as desired, as one example, the controller is designed such that depressing button 404 initiates motors 34 and 36, and depressing button 406 initiates only one of the motors, such as motor 36. By depressing button 404 or 405 both head movement and fluid flow can be initiated, with button 404 actuating one stream and button 405 actuating the other stream. By depressing button 406, only one of fluid flow and head movement can be initiated. Depressing button 404 or 406 can also halt the associated motor(s) subsequent to initiation. In cases where button 406 initiates and halts only motor 36, a user can, for example, brush without delivery of either component, and can rinse the oral care device 12 while the head rotates. The fluid level switches 408, 409 allow a user to choose between preselected rates of fluid delivery, such as high, medium and low rates. Three LED's 410 can selectively illuminate to indicate a selected fluid delivery level. As an alternative or in addition, an LCD display can be included to convey a fluid delivery level and/or can be used to display other information such as level of fluid in the oral care device 12 and/or status of battery charge.

The controller 400 may also be programmed to adjust a paste delivery level subsequent to initiation of the motor 34. In some embodiments, the controller is programmed such that a relatively large bolus of the two components is delivered soon after motor 34 is initiated, e.g., to have enough paste to begin brushing, and then the level of delivery is decreased, e.g., to a lower delivery level throughout the remaining portion of the brushing cycle. The level of paste delivery may be decreased, for example, by intermittent bursts of fluid and/or by slower rates of fluid delivery. As an example, the controller may be programmed to provide three delivery settings, low, medium and high. In one embodiment, at the low delivery setting, the controller is programmed to deliver a bolus by activating the motor 34 for about seven seconds. After about seven seconds, the controller intermittently activates the motor 34 for about 0.75 seconds and deactivates motor 34 for about 2.4 seconds (i.e., cycles the motor on and off at these intervals). In the same embodiment, at the medium delivery setting, the controller is programmed to deliver a bolus by activating the motor 34 for about seven seconds, and then to cycle the motor on for about 0.75 seconds and off for about 1.63 seconds. At the high delivery setting, the controller is programmed to deliver a bolus by activating the motor 34 for about seven seconds and then to cycle the motor on for about 0.75 seconds and off for about 1.2 seconds. Depending on the desired programming of the controller 400, more or fewer user interface controls can be used to initiate various functions.

Referring back to FIG. 3A, the motor 36 moves (e.g., translates linearly) the pivoting drive shaft 42, which in turn moves (e.g., oscillates rotationally) the rotatable head 20. The drive shaft 42 is connected to the rotatable head 20 using an offset design that facilitates placement of a fluid outlet at the head 20 and a tube 82 (or pair of tubes, if the two streams of material are to be kept separate) forming a portion of the fluid passageways within the neck 26 of the housing 16. This offset design is described in further detail in U.S. Ser. No. 10/861,253. Movement of the rotatable head 20 may be accomplished, in part, by use of a cam and follower system that translates rotational output of the motor 36 into linear motion used to drive the drive shaft 42 backward and forward. Such an arrangement is described in U.S. Ser. No. 10/861,253, incorporated by reference above.

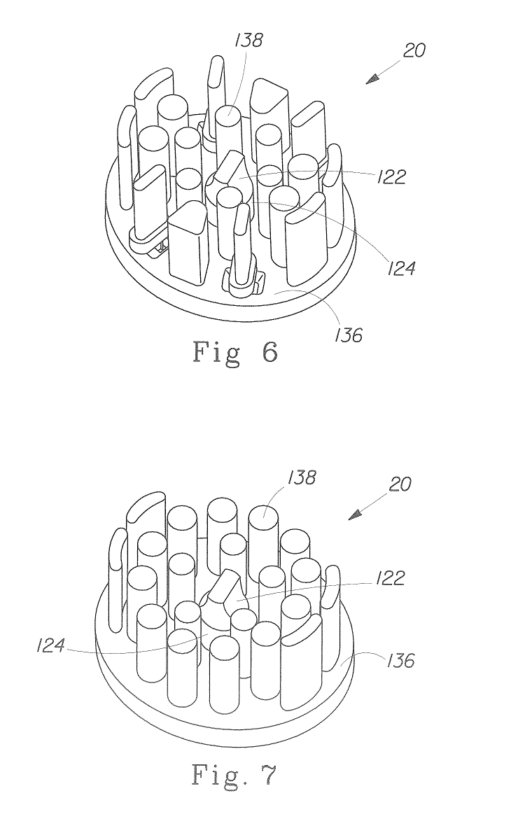

Referring now to FIGS. 6 and 7, head 20 includes a base 136 that has an opening 124 through which a valve 122, e.g., a duckbill valve as shown, extends outwardly. In some embodiments, the distal end of the tube 82 forms the fluid outlet without use of a valve attached thereto. If it is desired that the two streams be kept separate until they exit the head, two valves may be used, or a dual duckbill valve such as that described in U.S. Ser. No. 11/114,987, filed on Apr. 26, 2005, the complete disclosure of which is incorporated herein by reference. Extending from the base 136 is an array of bristle tufts 138. Although each tuft 138 is shown as a solid mass in the drawings, the tufts are actually each made up of a great mass of individual plastic bristles. For a more detailed discussion of brush heads, Applicants refer to pending U.S. application Ser. No. 10/666,497, filed Sep. 9, 2003, the disclosure of which is hereby incorporated by reference in its entirety.

When not in use, oral care device 12 can be coupled with docking station 14. Docking station 14 can be connected to an electrical outlet (not shown) or other suitable power supply. Referring to FIGS. 8A and 8B, docking station 14 is formed to hold oral care device 12 within the receiving portion 273 in an upright position. The receiving portion 273 includes a floor 275 extending between a vertical recess 295 formed in housing 291 and housing extension 297. The recess 295 is contoured to receive a portion of oral care device 12. The docking station 14 includes a reactive device, e.g., a sensor (not shown) that detects an input upon receipt of the oral care device by the docking station and, in response to this input, sends a signal to a controller, the details of which will be described in greater detail below.

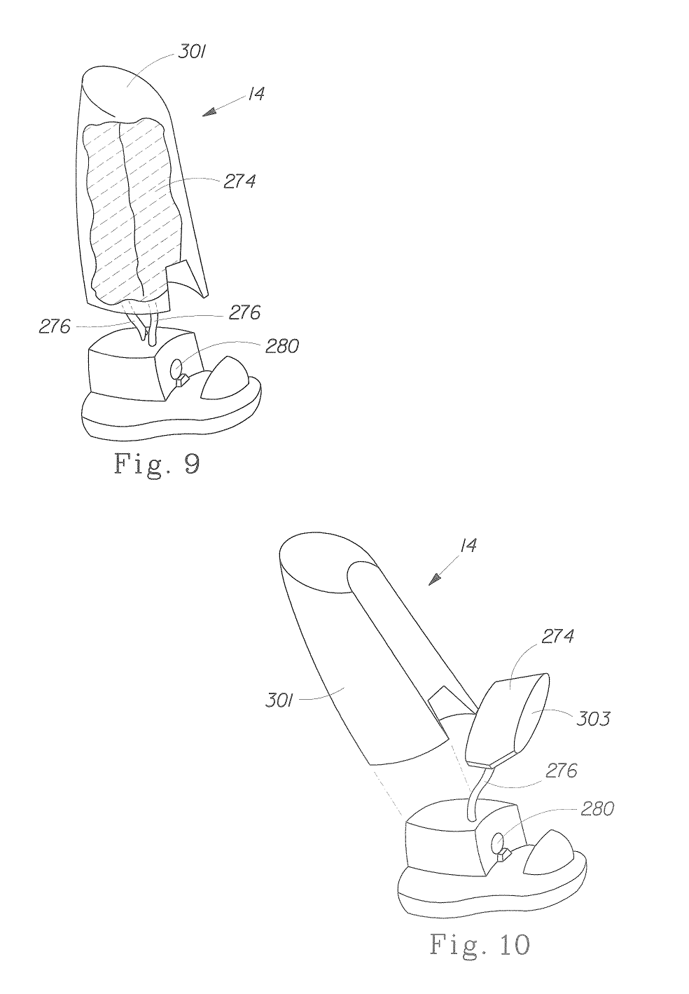

Referring now to FIGS. 8B and 9, the docking station 14 includes a multi-chamber fluid reservoir 274 the two chambers of which are coupled with tubes 276 to outlets 280. In some embodiments, e.g., as shown in FIG. 9, the fluid reservoir 274 is formed as an integral part of a separable, replaceable portion 301 of the docking station 14. In other embodiments, illustrated by FIG. 10, replaceable two pouches 303 (only one of which is shown in FIG. 10), from the fluid reservoir. In this case, the upper portion 301 of the docking station is removable, to allow the consumer to easily remove the pouches 303 when their contents are exhausted, or when the user wishes to use a different product, and insert a replacement pouch. Referring to FIG. 8B, to move the components from the fluid reservoir to the oral care device the docking station includes a pump assembly 282. Details of the refilling mechanism in the docking station are provided in U.S. Ser. No. 10/861,253.

Referring back to FIG. 8B, a pair of leads 336, 338 are exposed within the receiving portion 273 of the docking station 14. Leads 336, 338, are positioned to contact a pair of contacts 340, 342 (FIG. 2A) on the oral care device 12 when the oral care device 12 is placed within the receiving portion 173. This contact will electrically couple the oral care device 12 and the docking station 14, so that the power source to which the docking station is connected can recharge the rechargeable batteries within the oral care device. Contacts 340, 342 are electrically connected with the rechargeable batteries, allowing power to flow from the docking station to the batteries.

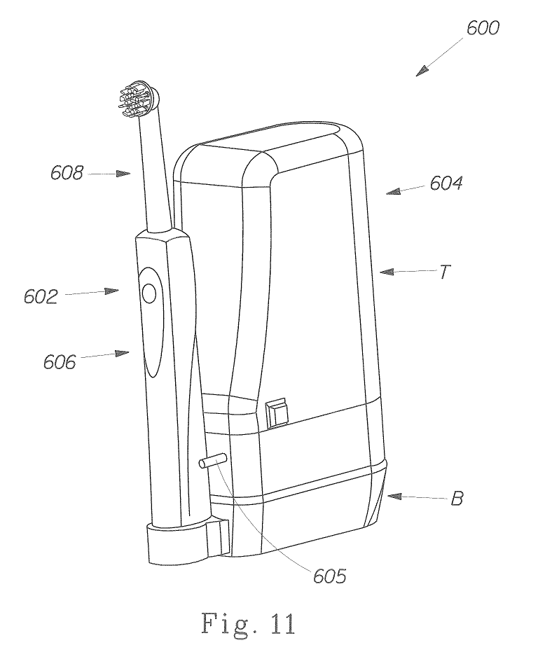

An oral care system 600 that is suitable for sequential delivery of two components is shown in FIG. 11. Oral care system 600 includes an oral care device 602, in the form of a toothbrush, and a docking station 604. The oral care device 602 is connected to the docking station 604 by a length of tubing 605, only a very small portion of which is shown in FIG. 11. Tubing 605 is flexible and is long enough to allow the user to easily manipulate the oral care device, e.g., about 2.5 to 3.5 feet long. Tubing 605 may be connected to the oral care device at any desired location, e.g., the head or handle, as will be discussed below.

Oral care device 602 includes a handle 606 and a detachable head/neck portion 608. The handle 606 does not include a pumping mechanism or a pump motor, as these components are provided in the docking station as will be discussed below. The handle 606 does contain a motor and other components necessary to drive the head, and may contain two fluid passageways.

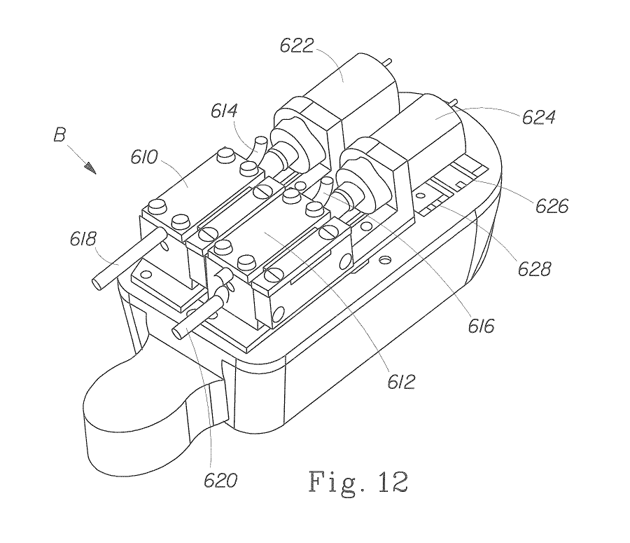

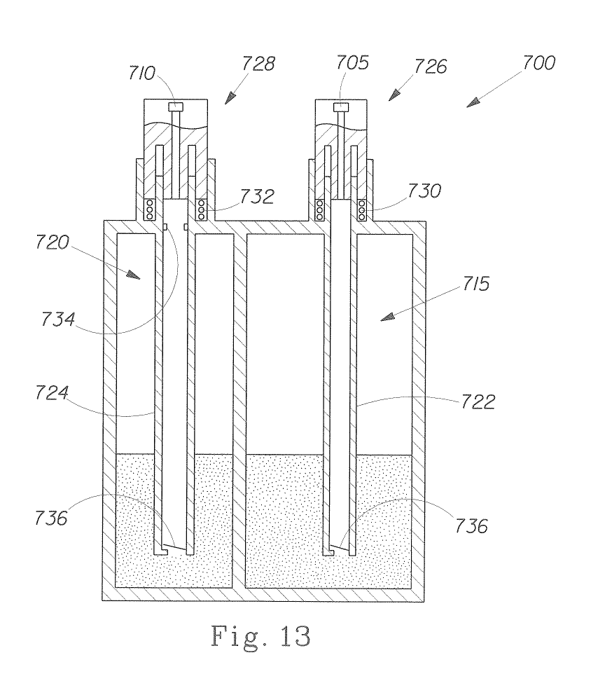

The docking station 604 includes a tower portion T and a base portion B. The tower portion contains two reservoirs (not shown), and is removable from the base portion so that the user can refill or replace the reservoirs. The base portion B, shown in detail in FIG. 12, carries two pumps 610, 612, which receive the two components from the reservoirs through tubes 614, 616 and deliver it to downstream portions 618, 620 of the tubes. After the tubes exit the docking station, they may be wrapped or otherwise contained in a single sheath to form the tubing 605 shown in FIG. 11. Pumps 610 and 612 are driven independently, by motors 622, 624. Firing of the motors is driven by a controller, e.g., one or more microprocessors, which may be mounted on printed circuit boards 626, 628.

If the tubing 605 enters the oral care device at the base or in the handle, the handle will contain tubing defining two fluid paths. If the tubing 605 enters the oral care device at the head, a standard handle containing only the head drive components may be used.

Any desired type of reservoir may be used to contain the two components in the oral care devices described above. Suitable reservoirs are described in U.S. Ser. No. 10/861,253, incorporated by reference above.

In another embodiment, the delivery device can be provided in the form of a dual compartmented dispenser which can be used alone or in combination with the electric toothbrush previously described. Referring to FIG. 13, a dual compartmented dispenser 700 having a first outlet 705 and a second outlet 710 is illustrated. The dispenser 700 has a first compartment 715 storing a first component and a second compartment 720 storing a second component. The first compartment 715 is in fluid communication with the first outlet 705 via tube 722, and the second compartment 720 is in fluid communication with the second outlet 710 via tube 724. In this embodiment, the first and second compartments 715 and 720 are not fluid communication with each other downstream so that the first and second components do not mix substantially mix, co-mingle or are otherwise dispensed together. A piston-type pump 726 can used to pump the first component from the first compartment 715 while separate piston-type pump 728 can be used to pump the second component from the second compartment 720. The pumps 726 and 728 can be biased by springs 730 and 732. One or more valves 736 can be provided to facilitate the action of the piston-type pump. The valves 736 can be provide as check-valves to allow a fluid to travel in only one direction. The first and second compartments can have the same or similar capacities. In another embodiment, the first and second compartments have different capacities, which can be useful where the amounts of the first and second components that are dispensed during an oral care regimen are different. An orifice 734 can be provided to meter the dosage of the first or second components for each stroke of the piston pump. Dosages can also be controlled by the size (e.g., bore) and/or stroke of the piston pump.

The first and second compartments 715 and 720 can be provided as replaceable cartridges that releaseably engage the housing 734 of the dispenser 700. For instance, the compartments 715 and 720 might threadably engage the housing the 734. The compartments 715 and 720 can be provided with different threads (pitch or size) so that each compartment is properly paired with the piston pump or orifice if there is different dosing or metering between the first component and the second component. While a first outlet and second outlet is illustrated, a single piston-type pump and outlet can also be provided, wherein the single piston-type pump and outlet can be placed in selective fluid communication with either the first or second compartments. Any of the components, dosing, or regimens, in whole or part, described herein can be used with the dispenser 700. While the dispenser 700 is one dispensing device suitable for use with the present invention, it will be appreciated that other dispensing devices can be used.

In one method of the present invention, a user dispenses the first component onto a toothbrush and proceeds with applying the first component to the oral cavity as part of a brushing regimen. After use of the first component, the user sequentially dispenses the second component onto the toothbrush and applies the second component to the oral cavity as part of the brushing regimen. Optionally, the user may rinse the brush and/or his/her oral cavity prior to application of the second component to the toothbrush. The toothbrush may contain a timer that activates a signal upon expiration of a predetermined time period to alert the user when it is time to switch between the first component and the second component or when to complete usage of the second component. In one embodiment, the second component is applied to a toothbrush or the oral cavity within about 15, 30, 45, 60, 120, 180, 240, 300, 360, 420, seconds or 10, 15, or 20 minutes of the first component being applied to a toothbrush or the oral cavity.

While the dispenser 700 has been illustrated as comprising a first and second compartment, it will be appreciated that more than two compartments can be provided. The dispenser 700 can be provided in wide variety of shapes, sizes, and configurations.

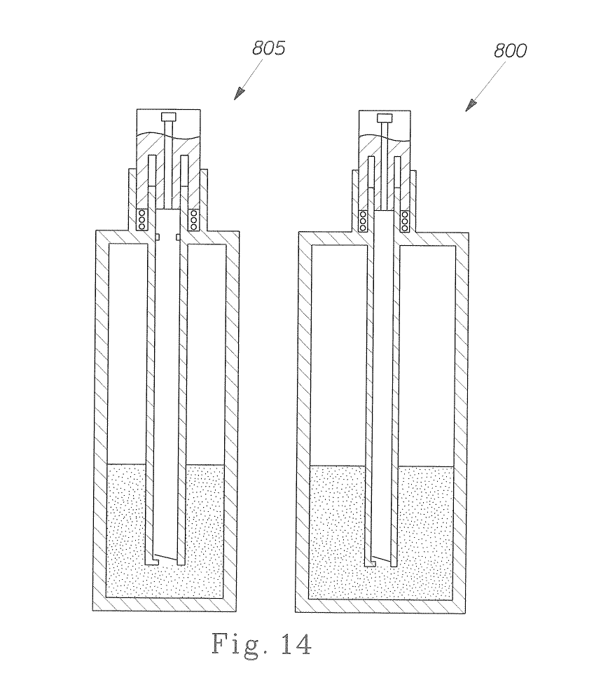

Referring to FIG. 14, in another embodiment, the first component and second component can be provided in completely separate packages, which may be bundled together as a kit. For example, a first component provided as a dentifrice could be provided in a first dentifrice dispenser 800 and a second component provided as a dentifrice could be provided in a second separate dentifrice dispenser 805. The first and second dispensers may be the same or different, and, for simplicity, have been shown comprising the same structures as the dispenser 700 (FIG. 13). A user could dispense a first amount from the first dentifrice package onto a toothbrush and, after brushing for a period of time with the first component, dispense an amount of the second component from the second dentifrice package onto the same toothbrush and complete the brushing regimen with the second component. The first and second dentifrice packages could be provided in visually distinct shapes, sizes, or color(s) so that a user can easily differentiate between the two. The first and second dentifrice packages might also be provided with graphics, text, icons, or numeric characters to differentiate between the two. In some embodiments, the first and second dentifrice packages can meter the first and second components so that a particular dose is delivered resulting in application of a controlled ratio between the first and second components.

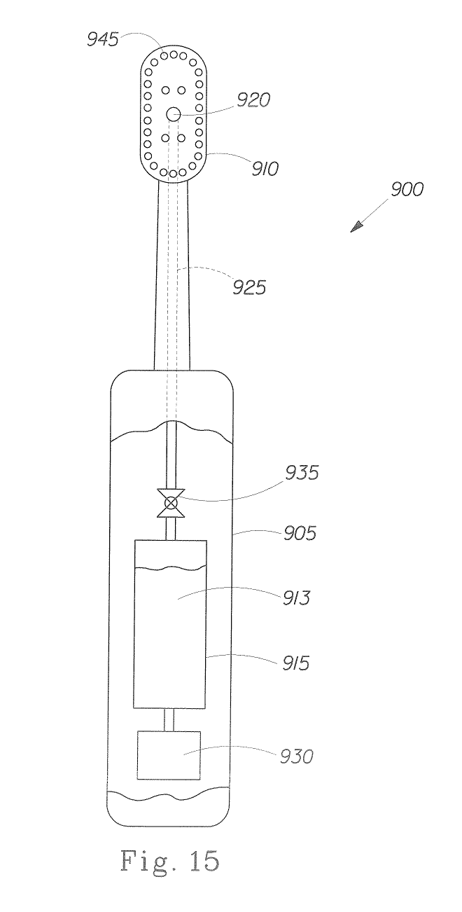

In yet another embodiment, the delivery device can be provided in the form of an oral care device that can dispense a liquid, such as a mouth rinse. The oral care device can be provided in the form of a toothbrush, some examples of which are described in U.S. Pat. Nos. 6,331,088; 6,047,429; 6,689,078; and 6,739,782. The toothbrush may be provided with movable bristle holders and/or static or non-movable bristle holders. The toothbrush head may be releasably attached to the toothbrush handle. Referring to FIG. 15, an example of a fluid dispensing toothbrush suitable for use with the present invention will now be described. The toothbrush 900 has a handle 905, head 910, and liquid reservoir 915 disposed in the handle. The liquid reservoir 915 can be a replaceable single use reservoir or refillable by a user of the toothbrush. The liquid reservoir 915 is in liquid communication with one or more outlets 920 disposed in the head 910. The outlet 920 is connected to the liquid reservoir 915 by conduit 925. A pump 930 is provided to pump or pressurize a liquid 913 within the liquid reservoir 915. The pump 930 can be provided in a variety of forms as known in the art. For example, a piston pump as described in U.S. Pat. No. 6,689,078 can be used. In one embodiment, the pump 930 can be an air pump that is used to pressurize the liquid in the reservoir 915. Once pressurized, the liquid may exit the reservoir when a valve 935 is opened. The valve 935 may be opened or actuated by depressing a button (not shown) on the handle 905.

A first component or composition, preferably in the form of a dentifrice although other forms may be used, can be applied by a user to the tufts of bristles 945 (or other tooth cleaning elements) of the head 910 of the toothbrush 900. The first component can include any of the ingredients (and combinations thereof) described herein and/or other ingredients known in the art. The first component is then applied to the hard and/or soft tissues of an oral cavity as the toothbrush is used. A second component or composition, preferably in the form of a liquid or rinse, can then be selectively applied to all or portions of the oral cavity by the toothbrush 900 at the beginning, during, or end (or combinations thereof) of a tooth brushing regimen by a user actuating or opening the valve 935. The second component can include any of the ingredients (and combinations thereof) described herein and/or other ingredients known in the art.

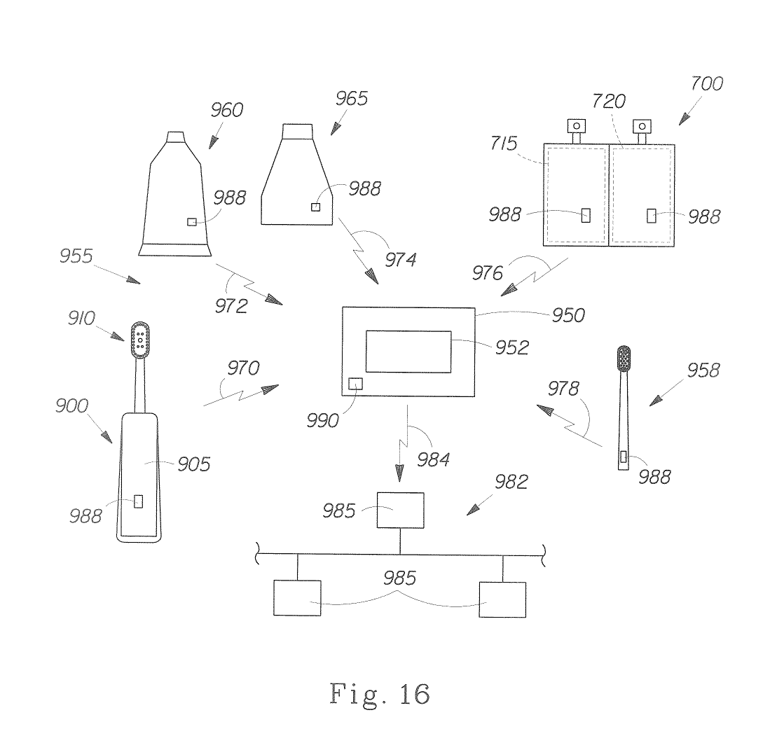

Referring to FIG. 16, one or more of the devices described herein can be used with a display 950 having a screen 952. Various arrangements are also further described in U.S. Ser. Nos. 60/859,226 field Nov. 15, 2006; 60/920,698 filed Mar. 29, 2007; and 60/912,111 filed Apr. 16, 2007. A system 955 comprising one or more oral care products such as dispensing toothbrush 900, a manual or electric toothbrush 958, a packaged dentifrice 960, a packaged rinse 965, and dual compartmented dispenser 700 are illustrated. Examples of some manual or electric toothbrushes 955 suitable for use with the present invention are described in U.S. Pat. Nos. 5,974,615; 5,930,858; 6,006,394; 6,108,869; 5,943,723; 6,308,367; 2003/0101,526; 2003/0154,567; 6,536,068; 2002/0129454; and 5,987,688. While certain devices and products are illustrated in FIG. 16 for simplicity, it will be appreciated that a variety of oral care devices may be used with the system 955, including other oral care devices and products described in this application. The oral care products can communicate using data links 970, 972, 974, 976, and 978 with the display 950, or an intermediary device which is then in data communication with the display 950. The one or more oral care products, displays, and/or system components described herein can be bundled together for distribution or sale to a user as a kit. The system 955 may also be connected to a network 982 via a data link 984. The network 982 can comprise one or more computers, servers and clients, or electronic devices 985.

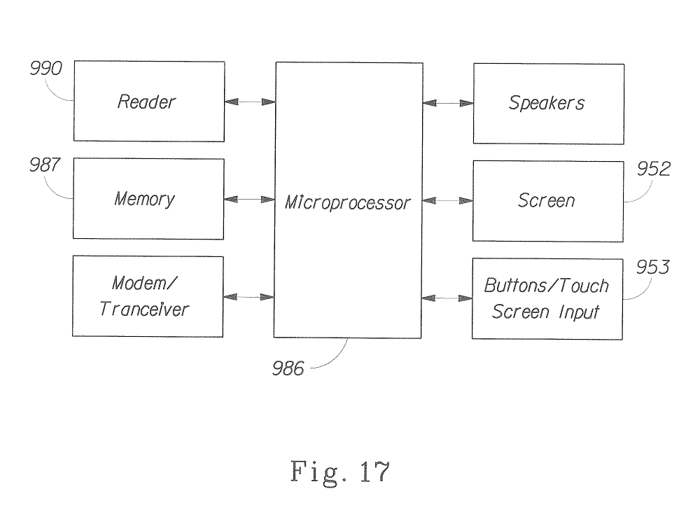

The oral care products and devices of the system 955 can use a variety of methods and devices to store, transmit and/or communicate data between the devices/products and the display 950. The term “data” is intended to refer to any digital or analog information in any form that is transferred or communicated. Data may include any data actively transmitted by a data transmitter and/or data that is passively detected by a data reader. Data may include ones and zeroes if the data that is communicated is digital. In another embodiment, data could be a series of digits, such as “12345678”, wherein each digit could represent information about a characteristic of an oral care device (e.g., for a manual toothbrush, the first digit could represent the brushing time in minutes, the second digit could represent the number of months until the brush should be replaced, the third and fourth digits could represent a type unique reward, etc.). Data may include the arrangement of optical elements (e.g., a bar code) that represents information. Data may include the presence or absence of electromagnetic energy (e.g., such as a magnetic field) and the like. The data may be stored, interpreted, decoded, or analyzed by a processor 986, shown in FIG. 17. For instance, where the data is a series of digits, such as “12345678”, the processor 986 and/or associated memory 987 could comprise a set of instructions that would be able to decode or interpret the data to determine what information is represented by the data.

A data transmitter is a device or component that actively transmits data to a data reader. A radio frequency identification tag, or RFID tag, is one example of a data transmitter. A data communicator is a device or component that may or may not actively transmit data but which has data that is capable of being detected. While a data transmitter, such as an RFID tag, is a type of date communicator, a data communicator need not necessarily actively transmit data. Examples of data communicators that contain data that that may be detected or read by a data reader but which do not actively transmit data include a bar code (wherein the bar code reader is the data reader), a spotcode, or a hall effect magnet (wherein the hall effect sensor is the data reader). Thus, as will be appreciated, the phrases “data communicators”, “data transmitters” and “data readers” are intended to encompass a wide variety of devices and arrangements for the transmission, communication, and/or detection of a variety of analog or digital data, including the mere detection of the presence of a data communicator. The phrase “data communication” is intended to encompass all the methods and forms by which data may be transmitted, communicated, and/or detected by a devices of the present invention, including data readers, data transmitters, data communicators, as well as data communication between a two components such as a display and any of the oral care products.

The data stored and/or transmitted or communicated by the RFID tag or other data transmitters/communicators can be quite varied. Some of the categories of data includes product identification data (e.g., the brand name or product name) and product usage or regimen data (e.g., usage time, such as 1 minute regimen for a rinse, text or graphical instructions concerning product usage, information concerning the sequence of usage, etc.), one or more rewards, and component or product replacement data (e.g., number of times or length of time that a component or product can be used before it should be replaced). Instructional images, text, or data can be particularly useful for children in establishing appropriate brushing regimens. Data can be directly displayed on the display 950 or can be used as an input to a processor 986 for a function or feature of the display 950. For example, each of the oral care products can be provided with an RFID tag 988 that can transmit usage or regimen data to a reader 990 associated with the display 950. In one embodiment, the usage data can be used as an input for a count-up or count-down timer that is displayed on the display 950. To initiate the data transmission from an RFID tag to a data reader 990 associated with the display 950, the oral care product containing the RFID tag need only be placed in sufficient proximity to the reader 990 to power-up the RFID tag.

In one embodiment, an oral care regimen can comprise placing the dentifrice package 960 (which can be any package, including a tube containing the dentifrice or an outer package such as a paper box) and the rinse package 965 in data communication with the display 950 (or an intermediary component that is in data communication with the display 950) in order to communicate data concerning the dentifrice (e.g., the amount of time to apply the dentifrice to the oral cavity) and rinse to the display 950. The dentifrice is applied to the head 910 of the toothbrush 900 and the liquid rinse is loaded into the liquid reservoir 913. The toothbrush 900 is then placed in data communication with the display 950, which initiates a timer whose time interval is displayed on the display 950 and which is set according to the data communicated by the RFID tag associated with the dentifrice package 960. The display 950 can display or send one or more audible and/or visual signals at the beginning, during, or at the end of the time interval indicating that the rinse 965 should be dispensed by the user of the toothbrush 900 based upon data communicated to the reader 990 by the data communicator of the packaged rinse 965. In one embodiment, the timer can initiate a second time interval that is displayed on the display 950 that can communicate either a time interval for dispensing the rinse to the oral cavity in order to approximate a dosing of the rinse and/or a time interval for use of the rinse in the oral cavity that approximates an application period. The second time interval can be set according to data communicated by the RFID tag (or other data communicator) associated with the rinse package 965. The dentifrice or first time interval can be between about 30 seconds and 3 minutes and the liquid rinse or second time interval can be between about 30 seconds and 3 minutes. The length of the time intervals can be varied depending upon the intended interaction between the dentifrice and the liquid rinse. It will be appreciated that the steps described herein can be performed in a variety of sequences and some steps may not need to be performed for each oral care or tooth brushing cycle. For example, it may not be necessary to refill the liquid reservoir 913 each time, and it may only be necessary to place the dentifrice and rinse packages in data communication with the display 950 once, such as the first time the dentifrice and rinse are used. Thereafter, the data communicated by the RFID tags can be stored in the memory 987 until deleted or replaced, such as when new dentifrice and rinse packages are purchased and first used. Further, while application of the dentifrice and rinse to an oral cavity has been described as sequential, it is contemplated that the application can occur simultaneously or generally so (e.g., the dentifrice is applied to the oral cavity and shortly thereafter the rinse is applied). The display 950 could also display other information, such as a visual guide to assist with application of the dentifrice or rinse to all four quadrants of the oral cavity. For example, a representation of the each quadrant of an oral cavity can be displayed on the display 950 to indicate when or for how long the dentifrice, rinse, or brushing action should be applied to that quadrant of the oral cavity.

In another embodiment, the dual compartmented dispenser 700 and/or the toothbrush 958 can be placed in data communication with the display 950. The dual compartmented dispenser 700 can be provided with one or more data communicators. In some embodiments, there maybe one data communicator associated with each compartment. The data communication with the display 950 can initiate a timer. The display 950 can then display a count-up or count-down time interval based upon the data that is transmitted by the data communicator of the toothbrush 958 and/or the compartmented dispenser 700. For instance, the data communicator, such as RFID tag 988, might communicate data representing the amount of time that the oral care composition of the first compartment 715 should be used. The RFID tag 988, or a second RFID tag associated with the second compartment 720, might also communicate data representing the amount of time that oral care composition of the second compartment should be used. For example, the RFID tag 988 might communicate that the oral care composition of the first compartment 715 should be applied to an oral cavity for 1 minute and that the oral care composition of the second compartment 720 should be applied to the oral cavity for 2 minutes. Upon communication of this data (or upon some other data communication, such as placing the toothbrush 958 in data communication with the display 950 or even upon manually initiating a timer of the display by actuation of a button or touch screen element 953), the display 950 can display a first time interval or timer for 1 minute. Upon expiration of the first time interval, the display 950 can display a signal or reminder to apply the second oral care composition from the second compartment 720 to the head of the toothbrush 958 (and/or additional actions, such are rinsing the toothbrush and/or the oral cavity prior to application of the second oral care composition, etc.) followed by application of the second oral care composition from the second compartment 720 to the oral cavity. The display 950 can display a second time interval or period, such as the aforementioned 2 minutes, for application of the second oral care composition to the oral cavity. The second time interval can be initiated by placing the toothbrush 958 in data communication with the display 950, by user activation of a switch, button, or other control on or associated with the display 950, or automatically after a pre-determined period of time. Upon expiration of the second time interval, the display 950 can provide an audio and/or visual signal that the second time interval has lapsed. After lapse of the second time interval, use of the second oral care composition may cease. As will be appreciated, other information can be displayed by the display 950 that is associated with the compartmented package 700 and/or the oral care compositions stored therein (e.g., instructional information, regimen or usage information (including historical user information), rewards, educational information, coupons, etc.). Further, while the system 955 has been described herein for purposes of simplicity with respect to the dual compartmented dispenser 700, it will be appreciated that the methods of the present invention can be used with any package comprising one or more compartments and/or oral care compositions or a plurality of individual packages that each contains one or more oral care compositions.

Oral Care Compositions and Components

Two component oral care compositions are described below. In some instances, it is beneficial or necessary to deliver two components to the mouth of a user separately, or to maintain two components of an oral care composition separate until use and then allow them to mix during delivery or in the oral cavity. This may be the case, for example, where the two components would react with and/or neutralize each other if stored together, or where ingredients in the two components are active at different pH levels, as discussed above in the Methods section. Examples of various two component compositions and their uses follow. As noted below, several of the compositions described may in some cases be provided as a single component which may be delivered sequentially or simultaneously with any other desired component, such as a standard dentifrice or mouthwash according to the methods discussed above.

The following discussion focuses on two component compositions, as such compositions can be advantageously delivered in whole or part using the methods and devices described above. However, it is noted that the methods and devices described above are equally suitable for delivering two unrelated components, e.g., a dentifrice and a mouthwash, two different flavored dentifrices, etc., as well as other two component compositions not mentioned below.

Malodor Treatment

The hard and soft tissues of the mouth are covered with microbial populations that contain bacteria with different metabolic capabilities. The Gram-positive bacteria within these microbial populations readily catabolize carbohydrates to produce acids which attack the hard tissues of the oral cavity, resulting in the formation of dental caries lesions (cavities). In contrast, the Gram-negative bacteria, especially the anaerobes, readily metabolize various amino acids contained in salivary (and to lesser extent other) peptides and proteins in the oral cavity to form end-products which favor the formation of oral malodor and periodontitis.

Oral malodor, clinically referred to as halitosis, can be caused by the putrefactive activity of these microorganisms on dental plaque, debris adhering to mucous membranes and salivary cellular elements to produce volatile sulfur compounds—primarily hydrogen sulfide, methyl mercaptan and traces of methyl sulfide.

Some two-component oral care compositions can reduce oral malodor, improve breath freshness, and/or prevent plaque accumulation. The first component of the oral care composition includes a metal salt, e.g., a copper salt such as Cu (II), and the second component of the oral care composition includes an oxidizer, e.g., a chlorite salt. The two components are kept separate until use or until just before use, for example in two compartments of a delivery device such as those described above. The components can be applied by a user in a single step, for example using a device described herein, rather than as a two step process such as first brushing one's teeth using a dentifrice and then using an oral care rinse.

Without wishing to be bound by theory, such compositions can reduce malodor with a two fold approach. To begin, the metal salt can lower the concentration of volatile sulfur compounds (VSC) by precipitating the VSC as metal sulfides. Using a distinct chemical pathway, the oxidizer oxidizes malodorous compounds, including amines and sulfides, to nonvolatile and thus, non-odorous forms. Additionally, the oxidizers and metal salts, especially Cu (II) salts, have antibacterial activity which can also have an anti-carries effect on the user.

In some embodiments, the two component composition can provide enhanced efficacy relative to the use of a single component oral care product (e.g., dentifrice or mouth rinse alone), or even in some instances using an oral care regime of a dentifrice followed by a mouthrinse. Accordingly, in some embodiments, a lower amount of active ingredient is applied in the two component compositions relative to what would be applied in a single component system in order to obtain substantially equivalent efficacy, or conversely the same amount of active ingredient will provide greater efficacy.

Examples of suitable metal salts include Cu, Zn, Ag, Sn, Mg, Fe, and Mn salts. In some preferred embodiments, the first component includes a copper salt, capable of releasing Cu(II) ions in solution. Examples of suitable copper salts include copper gluconate, copper chlorate, copper chloride, copper fluoride, and copper nitrate. In general, the copper salt is present in the first component at a concentration of from about 50 to 10,000 ppm, or about 200 to about 2000 ppm, for example, 500 to about 1000 ppm.

Examples of suitable oxidizing agents include chlorite salts, hydrogen peroxide, and perborates, perchlorates, peroxyacids, and hyperchlorates. In some preferred embodiments, the second component includes a chlorite salt, capable of releasing chlorite ions in solution. An examples of a suitable chlorite salts include sodium chlorite. In general, the chlorite is present in the second component at a concentration of from about 100 to 10,000 ppm, or about 1000 to about 4000 ppm, for example, from about 1600 to about 2400 ppm.

Each of the two components of the oral care composition can be independently formulated as a dentifrice or as a mouth rinse. In general, when each component of the oral care composition is formulated as a dentifrice, the components may be delivered simultaneously or sequentially to the mouth of the user. The first and second components can be delivered using a delivery device such as those described above. Each component of the oral care composition can be delivered in a single bolus, or alternatively can be delivered continuously during the brushing period of the user, for example at of rate of from about 0.01 mL/min to about 20 mL/min, or about 0.15 mL/min to about 1 mL/min over a two minute brushing period, or from about 0.15 mL/min to about 0.5 mL/min.

In another embodiment, both components of the oral care composition are delivered as a mouth rinse. Each component can be singularly administered, or alternatively, the two components can be mixed immediately before use. In general, from about 15 mL to about 30 mL of total mouth rinse is used for about 30 seconds, for example in a 1:1 ratio of components.

In another embodiment, one component can be administered as a dentifrice and the other as a mouth rinse. The components can be administered simultaneously or sequentially. In one embodiment, where the first and second component are simultaneously administered, the ratio of first and second component can be varied during administration of the oral care composition. For example, the oral care composition can be administered using an oral care device described herein such that the oral care composition is initially administered in a ratio of first component to second component of about 80:20 and throughout administration, the ratio of the first component to second component changes to about 20:80.

Other examples of oral care compositions that can improve oral malodor include dual component dentifrices described in U.S. Pat. No. 6,375,933, which is incorporated herein by reference in its entirety. These dentifrices include zinc and chlorite ion releasable compounds included in separate, semi-solid aqueous components. In some embodiments, the first component includes a zinc salt as the source of zinc ions and a chlorite salt as a source of chlorite ions in an orally acceptable vehicle having a substantially neutral pH of about 6.0 to 7.5, e.g., about 6.8. The second component has an acid pH of from about 2.0 to about 6.0, preferably about 4.0 to about 5.5. Mixing and combination of the two components of the oral care composition provides a pH of the final product of no greater than 6.5, preferably about 5.8 to about 6.4, thereby generating chlorine dioxide. The two components are preferably formulated with water, humectants, surfactant and abrasive to have similar physical characteristics, with an acid compound has been added to the acid component to adjust the pH to the desired acidity.

Suitable zinc ion releasable compounds are generally water soluble zinc salts including zinc nitrate, zinc citrate, zinc chloride, zinc sulfate, zinc bicarbonate and zinc oxalate with zinc nitrate being preferred. The zinc salt is generally incorporated in the neutral pH dentifrice component at a concentration of about 0.25 to about 10% by weight and preferably about 0.5 to about 2.0% by weight. Chlorite ion releasable compounds include alkali metal chlorites, alkaline earth metal chlorites, and any other transition metals, inner transition metal chlorites and/or polymeric salts. Water soluble chlorite salts are preferred. Examples of suitable metal chlorites include calcium chlorite, barium chlorite, magnesium chlorite, lithium chlorite, sodium chlorite and potassium chlorite. Mixtures of two or more sources of chlorite may also be used. The chlorite ion releasable salt is generally incorporated in the neutral pH dentifrice component at a concentration of about 0.5 to abut 5% by weight and preferably about 0.1 to about 1% by weight.

The acidic dentifrice component of the dentifrice composition contains an acid or mixture of acids to acidulate and thereby activate the chlorite compound present in the neutral dentifrice component, releasing chlorine dioxide when the two components are combined prior to use.

Acidic compounds which can be present in the acidic dentifrice component of the present invention include both mineral and organic acids, such as, sulfuric acid, hydrochloric acid, malic acid, alginic acid, citric acid, succinic acid, lactic acid, tartaric acid, potassium bitartrate, acid sodium citrate, phosphoric acid, and sodium acid phosphate. Acid phosphates are preferred, including phosphoric acid, or salts of phosphoric acid containing the PO₄ ion, as such acids or acid salts thereof, such as sodium phosphate monobasic, not only provide the necessary acidity, but also provide phosphate ions, to inhibit any tooth enamel demineralization which may occur with the application of the two component dentifrice to the teeth. The preferred acid, phosphoric acid, is commercially available as a liquid at 85% concentration. The acid is added to the dentifrice component in an amount to maintain the pH of the dentifrice at a pH of about 2.0 to about 6.0 and preferably about 4.0 to about 5.5 when the neutral and acidic dentifrice components of the present invention are combined, the pH of the combined compositions is between about 5.8 to about 6.4.

The composition may also include pyrophosphate salts having anticalculus efficacy, for example water soluble salts such as dialkali or tetraalkali metal pyrophosphate salts such as Na₄P₂O₇ (TSPP), K₄P₂O₇, Na₂K₂P₂O₇, Na₂H₂P₂O₇ and K₂H₂P₂O₇. Polyphosphate salts may include the water soluble alkali metal tripolyphosphates such as sodium tripolyphosphate and potassium tripolyphosphate. The pyrophosphate salts may be incorporated at a concentration of about 0.05 to about 2.0% by weight, and preferably about 0.5 to about 2% by weight, while polyphosphate salts may be incorporated at a concentration of about 1.0 to about 7.0% by weight.

Tooth Whitening Compositions

Examples of dual component oral care compositions that can be used for tooth whitening are described, for example, in U.S. Pat. No. 6,174,516, which is hereby incorporated by reference in its entirety.

Tooth whitening efficacy of a peroxide-containing dentifrice component can be substantially heightened by first applying to the teeth an aqueous rinse component having an alkaline pH, and subsequently applying the peroxide dentifrice to the teeth. The alkaline rinse tends to activate and promote the rapid release of oxygen from the peroxide contained in the dentifrice. Such sequential administration can be performed using the methods and devices described above. For example, the delivery device can be programmed to deliver the alkaline rinse and peroxide dentifrice sequentially, either as a single application of rinse followed by a single application of dentifrice, or in alternation (rinse, dentifrice, rinse, dentifrice, etc.).

In some embodiments, the aqueous rinse component includes about 70% to about 95% of water or a combination of water and ethanol, and preferably about 65% to 95% water and about 0% to 35% ethanol.

The peroxide compound is included in an amount sufficient to allow release of sufficient oxygen during brushing of teeth to effect whitening thereof. Preferably, the peroxide compound comprises from about 5 to about 15% by weight of the component. Examples of suitable peroxide compounds used to prepare the dentifrice components used in the practice of the present invention include calcium peroxide, hydrogen peroxide and peroxides including urea peroxide, glyceryl peroxide, benzoyl peroxide and the like. A preferred peroxide compound is urea peroxide.

Metal ion chelating agents, when included in the peroxide dentifrice component, can contribute to the chemical stability of the peroxide component when an abrasive such as calcined alumina or calcium pyrophosphate is also present in the dentifrice. Examples of suitable metal ion chelating agents include alkali metal stannates such as sodium and potassium stannate, ethylenediaminetetracetic acid (EDTA) and its salts. The metal ion chelating agents are incorporated in the dentifrice components at a concentration of about 0.01 to about 1% by weight.

In preparing the peroxide dentifrice components, the pH is adjusted to a range between about 3.0 and about 8 and preferably about between about 5 and about 7 with an acid such as phosphoric acid.

Flavor

Examples of oral care compositions that can promote improved flavor include those described in U.S. Pat. No. 6,696,047, which is hereby incorporated by reference in its entirety. Some two component oral compositions containing chlorite are stable against loss of chlorite via conversion to chlorine dioxide as well as against degradation of other composition ingredients such as flavors and sweeteners. In addition to maintaining the intended level of chlorite ion for efficacy, it is particularly important for oral care compositions that the flavor components do not degrade as consumer acceptability of the product is significantly influenced by the flavor and taste of the product.

In some embodiments, aqueous components are formulated at a basic pH so as to not undergo a substantial change in pH during storage. In some embodiments, when the two components are mixed the resulting compositions also do not exhibit the penetrating and unpleasant odor of chlorine dioxide, which could alter the flavor characteristics of the product.

The first component may include chlorite ion; and the second component may include a pharmaceutically-acceptable topical, oral carrier and comprising no chlorite. The first component can also include pharmaceutically-acceptable topical oral carriers which are compatible with chlorite ion. Preferably, the first component also includes one (or more) compatible binder(s), a buffer and/or a preservative. Preferably, the second component, which comprises no chlorite, includes flavorant, surfactant, fluoride ion, humectant, and/or abrasive.

The two components can be delivered simultaneously, and can be combined during dispensing, for example at a 1:1 volume to volume ratio to form the composition.

The concentration of chlorite ion in the composition can depend on the type of composition (e.g., toothpaste or mouth rinse) used to apply the chlorite ion to the gingival/mucosal tissue and/or the teeth, due to differences in efficiency of the compositions contacting the tissue and teeth, and due also to the amount of the composition generally used. The concentration may also depend on the disease or condition being treated.

It is generally preferred that the mouth rinse to be taken into the oral cavity have a concentration of chlorite ion in the range of from about 0.02% to about 0.5%, more preferably from about 0.10% to about 0.30% by weight of the composition. Preferably mouth rinse compositions of the present invention deliver about 3.75 to about 30.0 mg of chlorite ion to the oral cavity when approximately 15 ml of the rinse is used. Preferably for dentifrices (including toothpaste and tooth gels) and non-abrasive gels, the concentration of chlorite ion is in the range of from about 0.5% to about 3.0%, by weight of the composition. The above concentrations of chlorite ion represents the concentration of chlorite ion after the components are mixed together to form the composition. Thus, the concentration of chlorite ion in the chlorite containing component will vary depending on the amount of the second or additional components to be mixed with the chlorite-containing component to obtain the final composition.

Whole Body Health

In some embodiments, whole body health can be promoted in humans and animals by using one or two component topical oral compositions comprising a safe and effective amount of chlorite ion in admixture with a pharmaceutically acceptable carrier, said compositions being effective in controlling bacterial-mediated diseases and conditions present in the oral cavity and inhibiting the spread into the bloodstream of oral pathogenic bacteria and associated bacterial toxins and resultant inflammatory cytokines and mediators. These compositions can be applied topically to the oral cavity, using a safe and effective amount of chlorite ion to promote and/or enhance whole body health in humans and other animals.

Examples of oral care compositions effective for use in whole body health can be found, for example, in U.S. Pat. No. 6,846,478, which is incorporated by reference herein in its entirety. In some embodiments, topical oral compositions can be used for promoting whole body health in humans and animals, said compositions comprising a safe and effective amount of chlorite ion in admixture with a pharmaceutically acceptable carrier, and effectively controlling bacterial-mediated diseases and conditions present in the oral cavity and inhibiting spread into the bloodstream of pathogenic bacteria, associated bacterial toxins and resultant inflammatory cytokines and mediators.

Some embodiments include methods of use of these compositions by topical application to the oral cavity, to promote and/or enhance whole body health in humans and other animals. More particularly, the compositions can be used to reduce the risk in the development of cardiovascular disease, stroke, atherosclerosis, diabetes, severe respiratory infections, premature births and low birth weight (as well as postpartum dysfunction in neurologic and developmental functions), and associated risk of mortality. In a preferred method, the compositions are used to treat and prevent diseases and conditions of the oral cavity including periodontal disease, thereby promoting and/or enhancing enhanced whole body health for the individual being treated, as evidenced by the following health indices or biomarkers:

1) reduction in risk of development of heart attack, stroke, diabetes, respiratory infections, low birth weight infants, and post-partum dysfunction in neurologic/developmental function and associated increased risk of mortality;

2) reduction in the development of fatty arterial streaks, atherosclerotic plaques, progression of plaque development, thinning of the fibrous cap on atherosclerotic plaques, rupture of atherosclerotic plaques, and the subsequent blood clotting events;

3) reduction in carotid arterial (intimal) wall thickness (e.g., as assessed by ultra-sound techniques)

4) reduction in exposure of blood and systemic circulation to oral pathogens and/or their toxic components, specifically leading to reduction in blood levels of oral bacteria, lipopolysaccharide (LPS) and/or the incidence of oral pathogens and/or components thereof found in arterial plaques, arterial structures, and/or distant organs (e.g., heart, liver, pancreas, kidney);

5) reduction in the exposure of the lower respiratory track to the inhalation of bacterial pathogens and the subsequent development of pneumonias and/or exacerbation of chronic obstructive lung disease;

6) reduction in alterations in circulating hematocrit, hemoglobin, white blood cell count and/or platelet counts;

7) reduction in the incidence of disregulation in blood/serum levels of inflammatory mediators/cytokines such as TNF-alpha, IL-6, CD-14, and IL-1; 8) reduction in the incidence of disregulation of blood/serum levels of acute phase reactants including C-reactive protein, fibrinogen, and haptoglobin;

9) reduction in the incidence of disregulation of blood/serum markers of metabolic disregulation including homocysteine, glycosylated hemoglobin, 8-iso-PGF-2 alpha, and uric acid;

10) reduction in incidence of disregulation of glucose metabolism as typically assessed by impaired glucose tolerance test, increased fasting blood glucose levels, and abnormal fasting insulin levels; and

11) reduction in disregulation of blood lipid levels specifically including blood or serum cholesterol, triglycerides, LDL, HDL, VLDL, Apolipoprotein B, and/or Apolipoprotein A-1.

Without wishing to be bound by theory, it is believed that the compositions promote overall body health by controlling bacteria-mediated diseases and conditions present in the oral cavity and thus, preventing the spread of bacteria, bacterial toxins and endotoxins and inflammatory mediators/cytokines into the bloodstream and other parts of the body.

In some embodiments, the oral care compositions include therapeutic rinses, especially mouth rinses, as well as toothpastes, tooth gels, tooth powders, non-abrasive gels (including subgingival gels) comprising:

(a) a safe and effective amount, preferably a minimally effective amount, of a chlorite ion agent; and

(b) a pharmaceutically-acceptable topical, oral carrier; wherein the final composition is essentially free of chlorine dioxide or chlorous acid and wherein the composition is essentially free of hypochlorite ions or hypochlorite salts and has a final pH greater than 7, preferably greater than 7.5, and even more preferably from about 8 to 12. Preferably the chlorite ion agent is incorporated in the present compositions in an amount to comprise from about 0.02% to about 6.0%, by weight of chlorite ion.

By “essentially free of chlorous acid or chlorine dioxide” as used herein is meant a composition which comprises very low levels, e.g. less than about 2 ppm, preferably less than about 1 ppm of chlorine dioxide or chlorous acid, using known analytical methods for measuring chlorine dioxide or chlorous acid including highly specific electron spin resonance (ESR) spectroscopy.

Preferably, the present compositions further comprise one or more additional therapeutic agents selected from the group consisting of: antimicrobial/antiplaque agents, biofilm inhibiting agents, anti-inflammatory agents (including cyclo-oxygenase inhibitors and lipoxygenase inhibitors), H2-antagonists, metalloproteinase inhibitors, cytokine receptor antagonists, lipopolysaccharide complexing agents, tissue growth factors, immunostimulatory agents, cellular redox modifiers (antioxidants), analgesics, hormones, vitamins, and minerals.

In some embodiments, for example, where the compositions comprise an additional therapeutic agent, the compositions can include a first component that comprises a chlorite ion and a second component comprising the additional therapeutic agent.

Chlorite Ion Source

In some embodiments, the chlorite ion as an essential ingredient in the compositions and methods described. The chlorite ion can come from any type of chlorite salt. Examples include alkali metal chlorites, alkaline earth metal chlorites, and any other transition metals, inner transition metal chlorites and/or polymeric salts. Water soluble chlorite salts are preferred. Examples of suitable metal chlorites include calcium chlorite, barium chlorite, magnesium chlorite, lithium chlorite, sodium chlorite and potassium chlorite. Sodium chlorite and potassium chlorite are preferred. Sodium chlorite is particularly preferred. Mixtures of two or more sources of chlorite may also be used.

For dentifrice compositions, the level of chlorite ion is greater than about 0.005%, 0.01%, 0.02%, 0.4%, 0.6%, 0.75%, and/or less than about 2%, 1.5%, or 1% by weight of the composition.

For mouthrinse compositions, the level of chlorite ion is greater than about 0.02%, preferably greater than about 0.075%, more preferably greater than about 0.15%, by weight of the composition.

For methods of treating or preventing gingivitis, preferably the compositions comprise from about 0.1% to about 6%, of chlorite ion, by weight of the composition.

Chlorite salts are available from various suppliers as sodium chlorite. Sodium chlorite is commercially available as a technical grade powder or flake, and as an aqueous liquid concentrate in a range of concentrations. Example of sources of sodium chlorite include: sodium chlorite available from Aragonesas and from Vulcan. These sources generally have no more than 4% sodium chlorate as well.

Preferably, the source of chlorite ion has high purity, e.g. 70% or greater. Furthermore, preferably the compositions of the present invention are essentially free of hypochlorite metal salt or hypochlorite ion, dichloroisocyanurate, or salts thereof.

Preferably, the level of chlorite ion is measured by gradient separation of inorganic and organic acid anions using Ion Pac ASII exchange column, available from Dionex Corporation, Sunnyvale, Calif.

The final compositions of the present invention preferably comprise low levels of chlorine dioxide or chlorous acid, or are essentially free of chlorine dioxide or chlorous acid (i.e., have less than about 2 ppm, preferably less than about 1 ppm of chlorine dioxide or chlorous acid).

For dual component compositions the level of chlorine dioxide or chlorous acid is measured within about 2 to 3 minutes after the two components are mixed together.

The pH of the final composition is generally greater than 7, preferably greater than 7.5, more preferably from 8 to 12; still more preferably the pH is from 9 to 10.

Improved Sensory Attributes

Examples of dentifrices having improved sensory attributes are described, for example, in U.S. Pat. No. 5,820,854, which is incorporated herein by reference in its entirety. These dentifrices may be provided and delivered as a single component, or as two component compositions.

The sensory attributes of a dentifrice with a high ionic strength, i.e., from about 1,000 μmho to about 50,000 μmho, can be improved sensory by the addition of polyoxyethylene. The dentifrice provides an increased foam volume, increased foam viscosity, and a smooth teeth feeling. In a dual component dentifrice, the polyoxyethylene may be present in a second dentifrice component which is dispensed side-by-side with the high ionic strength dentifrice component. Alternatively, the polyoxyethlene may be included in the high ionic strength dentifrice component, and the second stream dispensed by a delivery device may be a different component, e.g., a mouthrinse or another type of dentifrice. The polyoxyethylene may have a molecular weight of from about 100,000 to about 10,000,000 or about 200,000 to about 7,000,000.

In some embodiments, a dual component dentifrice includes a first dentifrice component having an ionic strength of from about 1,000 μmho to about 50,000 μmho and comprising from about 0.1% to about 8% of a polyoxyethylene having a molecular weight of from about 100,000 to about 10,000,000 or about 200,000 to about 7,000,000 and from about 92% to about 99.5% of one or more aqueous carriers; and a second dentifrice component. In an alternative embodiment, the dentifrice includes a first dentifrice component having an ionic strength of from about 1,000 μmho to about 50,000 μmho; and a second dentifrice component comprising from about 0.1% to about 8% of a polyoxyethylene having a molecular weight of from about 100,000 to about 10,000,000 or about 200,000 to about 7,000,000 and from about 92% to about 99.9% of one or more aqueous carriers.

Examples of suitable polyoxyethylenes include those having a molecular weight of from about 100,000 to about 10,000,000 or about 200,000 to about 7,000,000. Preferably, the molecular weights will be from about 600,000 to about 2,000,000, and more preferably from about 800,000 to about 1,000,000. “Polyox” is the tradename for a high molecular weight polyoxyethylene produced by Union Carbide. The polyoxyethylene is generally present in an amount of from about 0.1% to about 8%, preferably from about 0.2% to about 5%, and more preferably from about 0.3% to about 2%, by weight of the dentifrice component.

High ionic strength in a dentifrice will occur when the dentifrice contains ingredients having an ionic character. Commonly used ingredients with ionic character include materials such as salts and surfactants. Dentifrices with high salt levels and/or high surfactant levels will have a high ionic strength. Ionic strength of a dentifrice is measured by conductivity of the dilute slurry. The slurry is a 3:1 water to dentifrice slurry. Preferably the dentifrice will have an ionic strength of from about 5,000 μmho to about 40,000 μmho and more preferably from about 10,000 μmho to about 25,000 μmho. The total salt level of dentifrices with high ionic strength is generally from about 4% to about 70%, preferably from about 6% to about 60%, and more preferably from about 8% to about 50%.

Remineralizing

Examples of two component oral care compositions having remineralizing characteristics are described, for example, in U.S. Pat. No. 4,083,955, which is incorporated herein by reference in its entirety.

Subsurface dental enamel cay be remineralized by the sequential application of certain soluble salts yielding ions which will react to form a desirable remineralizing precipitate. Salt solutions, such as calcium and phosphate salt solutions, cay be sequentially applied to dental enamel to effect remineralization.

Subsurface remineralization of tooth enamel with a desirable precipitate cay be accomplished by a process utilizing a first component comprising a water-soluble compound capable of acting as a source of the cation of the desirable precipitate, and a second component comprising a water-soluble compound capable of acting as a source of the anion of the desirable precipitate. The process comprises the steps of: (1) applying one of the above components to the surface of a tooth, and thereafter, (2) applying the other component to the surface of the tooth, whereby the desired ion of the other component diffuses into the demineralized subsurface and forms the desirable precipitate with the ions of the first component, thus effecting remineralization of the demineralized subsurface. The duration of step (1) may be selected to allow the desired ion to diffuse into the demineralized subsurface.

For example, in the first step, a component including a reactant solution of a soluble salt is placed in contact with the tooth surface nearest to the demineralized subsurface. In this first reactant solution are selected cations which diffuse through the tooth surface to its demineralized subsurface. In the second step, a second component including a reactant solution containing selected anions is placed in contact with the tooth surface nearest the demineralized subsurface. The anions diffuse through the tooth surface to the demineralized subsurface where they come in contact with the cations previously deposited and form a precipitate which is bound to the tooth structure. As a result, the tooth's subsurface is remineralized.

Concentrations of the cationic and anionic solutions may be from 0.005 to 10% or the limit of solubility of the salt, with from about 0.05 to about 5% preferred. Excess salt can be present, if desired. More than one cation may be employed in the cationic solution. Equivalent concentrations in the cationic and anionic solutions are not necessary since in each step an excess of the reactant is required in order to promote diffusion into the tooth's demineralized subsurface. Similarly, more than one anion may be employed in the anionic solution. There is a visible effect on “white spots” after as few as eight sequential applications, and it is contemplated that several sequential applications will be employed to achieve the most beneficial results.

In order to effect remineralization of the dental enamel, a therapeutic amount of the desired cations and anions may be employed in the oral cavity. The amount of solution placed in the mouth should generally contain at least about 0.001 g. of desired cations and about 0.001 g. of desired anions and preferably contains more than about 0.1 g. of desired cations and about 0.1 g. of desired anions and/or less about 10 g of the desired cations/anions and/or less than about 5 g of the desired cations/anions, or less than about 2 g of the desired cations/anions.

While the length of time of contact between the salt solutions and the tooth's surface is not critical, it is necessary for the length of time to be great enough to allow diffusion of the ions through the tooth's surface to the demineralized subsurface. It is believed that at least ten seconds is required for this diffusion.

Each solution should have a pH of from about 3 to about 10 before and after the precipitation reaction, and be otherwise compatible in the oral environment. The ions must not combine prematurely in the solution to form a precipitate, but must be able to diffuse through the surface of the tooth to a demineralized subsurface area and be able to form an insoluble salt with ions of the other solution. The solutions and the insoluble precipitates are preferably not colored, and, or course, have acceptable levels of toxicity (i.e., the particular ions, in the amounts used in the remineralization process, must be non-toxic).

Although many precipitates may be used for remineralization, by depositing a precipitate less soluble than the original enamel, the remineralized subsurface can be made to be more resistant to demineralization than was the original enamel. If remineralization is carried out in the presence of either a heavy metal ion or fluoride ion, the remineralized enamel is more resistant to demineralization than was the original enamel. If both ions are present, the remineralized enamel is even more resistant to demineralization. The concentration of salt containing heavy metal ion and fluoride ion in their respective solutions may be from about 0.005 to about 10%, e.g., from about 0.005 to about 0.1%.

Examples of suitable heavy metal ions are aluminum, manganese, tin, zinc, indium, and rare earth metals such as lanthanum and cerium.

In certain implementations, the remineralizing cationic solution contains from about 0.005 to about 10%, preferably about 1%, of a soluble calcium salt yielding calcium ions and from about 0.005 to about 10%, preferably from about 0.005 to 0.1% of a soluble indium salt yielding indium ions. The remineralizing anionic solution contains from about 0.005 to about 10%, preferably about 1%, of soluble phosphate salt yielding phosphate ions and from about 0.005 to about 10%, preferably from about 0.005 to about 0.1% of a soluble fluoride salt yielding fluoride ions. The resulting precipitate is a calcium phosphate or hydroxylapatite, the natural constituent of tooth enamel, with incorporated indium and fluoride ions. Not only does this process result in remineralized enamel, but the remineralized enamel is more resistant to subsequent demineralization than was the original enamel.

Suitable soluble fluoride and indium salts include, but are not limited to, sodium fluoride, zinc fluoride, betaine fluoride, alanine stannous fluoride, hexylamine fluoride, indium chloride, indium sulfate, and indium nitrate.

The anions which give desirable insoluble precipitates include phosphate, fatty acid groups having from 8 to 18 carbon atoms, fluoride, fluorophosphate, silica fluoride, sulfate, tartrate, sorbate, alkyl sulfonates having from 6 to 18 carbon atoms, carbonates, etc. Mixtures of these anions are desirable.

Cations which give desirable insoluble precipitates include the heavy metal ions referred to hereinbefore, and calcium and magnesium. Mixtures of these cations are desirable.

These cations and anions which form the insoluble remineralizing precipitates can be obtained from solutions of the corresponding soluble salts. Suitable soluble salts of the cations used in this invention include the halide, e.g., chloride, nitrate, sulfate, acetate and gluconate salts of the desired cation. Similarly suitable soluble salts of the anions of this invention include alkali metal (e.g., sodium and potassium), ammonium, and low molecular weight substituted ammonium salts. Examples of low molecular weight substituted ammonium salts are those where one or more of the hydrogen atoms on the ammonium ion is substituted with a 1-3 carbon atom, alkyl or hydroxy alkyl group such as methyl, ethyl, propyl, hydroxyethyl, 2-hydroxypropyl, or 3-hydroxypropyl, e.g., the mono-, di-, or triethanolammonium salts or the mono-, di-, or triethylammonium salts.

The many different cations and anions with which one could remineralize tooth enamel combine to form many different precipitates. Most preferred precipitates are calcium phosphate compounds with small amounts of indium and fluoride incorporated therein. The following precipitates disclose not only desirable remineralizing precipitates but, of course, also the cations and anions necessary to form the precipitates. It will be recognized by one skilled in the art that some of these precipitates can be formed by first forming an original precipitate which then further reacts to form the indicated precipitate. For example, a hydroxide may form first and then react further to form the corresponding oxide.

Preferred precipitates are: calcium phosphates; ZnNH₄PO₄; InPO₄; rare earth phosphates such as lanthanum, cerium and samarium phosphate; rare earth fluorides such as lanthanum, cerium, praseodymium, neodymium, and samarium fluorides; magnesium alkyl sulfonate wherein the alkyl group has from 10 to 22 carbon atoms; magnesium stearate; calcium stearate; zinc stearate; and aluminum phosphates.

The components of the precipitate can be sequentially delivered to the surface of the tooth by means of two separate delivery vehicles, each containing one component, e.g., a mouthwash and a toothpaste. For example, the components of the precipitate can be delivered using an oral care device described herein.

Reducing Tooth Sensitivity

Examples of two component oral care compositions that can reduce tooth sensitivity are described, for example, in U.S. Pat. No. 6,953,817, which is incorporated herein by reference in its entirety.

Desensitizing dentifrice compositions are formulated to eliminate or reduce the discomfort and pain associated with dentinal hypersensitivity. Such compositions include two-component desensitizing dental compositions containing potassium salt desensitizing agents.

The dental compositions can include two semi-solid aqueous components: a first component buffered to maintain an alkaline pH of at least about 9.0 and preferably about 9.0 to about 12.0, and a second component maintained at a pH of 6.5 to 7.5 with a phosphate salt buffer ingredient. At least one of the components contains a fluoride ion-releasing salt and a potassium-releasable salt compound in an orally acceptable vehicle, the fluoride compound being present at a concentration sufficient to release about 2500 to 8800 parts per million (ppm) fluoride from the compound. Upon mixing and combination of the components a composition having a pH of from about 6.5 to about 7.0 is formed. Upon repeated application of the mixture to the teeth, increased relief from dentinal hypersensitivity is experienced by the user.

The two components are preferably combined in approximately equal weight proportions, so that about one-half of the concentration of any particular ingredient within either component will be present when the components are combined and applied to the teeth, as by brushing. Both components are preferably formulated to have similar physical characteristics, so that the two components may be simultaneously delivered in the desired predetermined amounts.

To prepare the dentifrice component having a substantially neutral pH, a buffering agent is incorporated, which is normally prepared using a vehicle which contains water, humectant, surfactant and an abrasive. The buffering agent is preferably a mixture of mono- and dibasic sodium phosphate salts and is incorporated in dentifrice component at a concentration of about 5 to about 10% by weight and preferably about 6 to about 10% by weight of in the component.

The dentifrice component having an alkaline pH is prepared using a vehicle having a composition similar to that of the buffered neutral pH component. An alkaline agent such as an alkali metal compound including sodium hydroxide, potassium hydroxide, sodium bicarbonate, sodium carbonate, N-sodium silicate (a 3.22 weight ratio of sodium silicate in 34.6% water available from PQ Corporation) is incorporated in the alkaline component in amounts in the range of about 0.5 to about 15% by weight, preferably about 1.0 to about 8% by weight and most preferably at about 1.0 to about 5.0% by weight of the component. Mixtures of the above alkali metal compounds can also be used.

The fluoride ion-releasing salts are characterized by their ability to release fluoride ions in water. It is preferable to employ a water soluble fluoride salt providing about 1000 to about 9000 ppm of fluoride ion, and preferably about 2500 to about 8800 ppm of fluoride ion. Suitable examples of fluoride ion-releasing salts include water soluble inorganic metal salts, for example, sodium fluoride, potassium fluoride, sodium monofluorophosphate, stannous fluoride and sodium fluorosilicate. Sodium fluoride, sodium monofluorophosphate and stannous fluoride are preferred fluoride ion releasing salts.

The source of desensitizing potassium ion is generally a water soluble potassium salt including potassium nitrate, potassium citrate, potassium chloride, potassium bicarbonate and potassium oxalate with potassium nitrate being preferred. The potassium salt is generally incorporated in one or more of the dentifrice components at a concentration of about 1 to about 20% by weight and preferably about 3 to about 10% by weight.

Prevention of Gum Disease

Examples of two component oral care compositions that prevent gum disease are described, for example, in U.S. Pat. No. 5,281,410, U.S. Pat. No. 5,145,666, U.S. Pat. No. 4,849,213, U.S. Pat. No. 4,528,180, and U.S. Pat. No. 5,632,972, which are incorporated herein by reference in there entirety.

Some oral care compositions are capable of reducing plaque and gingivitis while at the same time not incurring significant staining. Staining can be reduced by the use of a dual component composition containing pyrophosphate ions and stannous compounds, e.g., with stannous fluoride and another stannous compound in one component and pyrophosphate ions in another. Both components generally include a pharmaceutically acceptable carrier.

Stannous fluoride is the first essential component of the stannous components. This material is present in the stannous composition at a level of from about 0.05% to about 1.1%, preferably from about 0.4% to about 0.95%. It should be recognized that separate soluble stannous and fluoride salts may be used to form stannous fluoride in-situ as well as adding the salt directly. Suitable salts for forming stannous fluoride in-situ include stannous chloride and sodium fluoride among many others.

A second stannous compound is generally included in the stannous component. The second stannous compound is a stannous salt of an alpha hydroxy acid, phytic acid, EDTA, glycine and mixtures thereof. In some embodiments, the second stannous compound is stannous gluconate. These materials are known stannous chelates and may be provided to the present compositions as the chelate or as separate soluble stannous salts and the chelate formed in-situ such as with stannous fluoride. Suitable alpha hydroxy-acids include gluconic acid, citric acid, malic acid, tartaric acid and lactic acids. Such salts include stannous chloride and stannous fluoride. The second stannous compound is generally present in the present components at a level of from about 0.1% to about 11%, preferably from about 2% to about 4%.

The second component is a component containing or capable of providing an effective amount of pyrophosphate ions. The pyrophosphate ion can be, for example, pyrophosphate acid or any of the readily water soluble pyrophosphate salts. Such salts include any of the alkali metal salts such as sodium, potassium and lithium and also including ammonium.

The amount of pyrophosphate ions is any effective amount generally from about 1% to about 15%, preferably from about 1% to about 10%, most preferably from about 3% to about 7%.

In some embodiments, the components can be applied to the oral cavity in safe and effective amounts. These amounts (e.g. from about 0.3 to about 15 g), if it is a toothpaste or mouthwash, are kept in the mouth for from about 15 to about 60 seconds. The components can be used in any order but it is preferable that the stannous component be used first.

In some embodiments, hydrogen or urea peroxide is dissolved in a nontoxic gel for use in combination with a separately stored but substantially simultaneously dispensed paste containing sodium bicarbonate, table (or another suitable) salt, and, preferably, additional cleansing, anticaries and polishing agents as well as an effective concentration of flavoring substances.

Controlled quantities of the gel and paste can be simultaneously released onto the toothbrush and immediately applied to the teeth and gums. Control of the peroxide, salt, and NaHCO₃ quantities delivered may be thus effected by specification of the opening of the orifice and the active ingredient concentration in each tube (or pump compartment). When the brush is applied to teeth and gums, immediate mixing of the products takes place followed by the rapid evolution of active oxygen and carbon dioxide. At the same time, the effervescence accompanying release of active oxygen activates the flavor contained in the bicarbonate paste and produces a lasting highly refreshing taste in the mouth which is unlike any other flavor provided by existing toothpastes or gels.

The hydrogen peroxide gel may contain the following ingredients in the following amounts —H₂O₂: about 1.0-10.0% and preferably about 3.0-6.5%; Acrylic acid copolymer: about 0.05-1.20% and, preferably, about 0.3-0.8%; nonionic cellulose gum: about 0.1-1.5% and, preferably, about 0.3-0.8%; neutralizing agent (triethanolamine, diisopropanolamine, NaOH, KOH): an amount sufficient to raise the gel pH to about 3.0-6.0. The balance is purified (distilled or deionized) water.

The sodium bicarbonate paste contains sodium bicarbonate, sodium chloride, purified (distilled or deionized) water and a thickener/stabilizer such as cellulose gum and magnesium-aluminum silicate, as essential ingredients. In order to disperse the “chalky” taste imparted mostly by the bicarbonate, a bodying agent is added, such a sorbitol, glycerin or a glycol. In addition, if the paste, in combination with the gel, is to displace toothpaste completely, cleansing agents, such as calcium sulfate, calcium phosphate and hydrated aluminum oxide, as well as a foaming agent such as sodium lauryl sulfate (which also enhances the peroxide-bicarbonate-salt action) may be added.

The constituents and quantities for the bicarbonate paste are as follows: sodium bicarbonate: about 10-50% and preferably 20-40%; polyol: about 5-30% and preferably, 15-25%; cellulose gum: about 1-3% and preferably 1.2-1.8%; sodium chloride: about 1-6% and preferably about 2-4%; polishing agent/cleanser: about 1-40%, preferably about 1.5-30%; foaming agent: about 0.1-2.5% and preferably about 0.2-0.5%; flavoring agent(s): to taste, less than about 1%; preservatives: about 0.1-0.5%. The balance is purified water. The paste and the gel are preferably used in substantially equal proportions, by volume.

In some embodiments, gingival bleeding may be inhibited, and the texture and consistency of gingival and periodontal tissues improved, by delivering to the oral cavity a first component comprising from about 0.1 to about 10% by weight of zinc salt in a pharmaceutically acceptable carrier, and a second component comprising from about 1 to about 80% by weight of a bicarbonate salt in a pharmaceutically acceptable carrier, and agitating the combination of first and second compositions within the mouth against the gingival and periodontal tissues, or brushing gingival and periodontal surfaces surrounding the teeth simultaneously with a combination of the first and second components.

In a preferred embodiment, the first component can also include a peroxygen compound. Another embodiment utilizes ascorbic or citric acids in place of the peroxygen compound.

This combination of zinc and bicarbonate salts can deliver a very potent inhibitory effect against gingival and periodontal tissue damage. Such effect requires the zinc and bicarbonate salts to be separately packaged prior to their introduction into the oral cavity. For example in an oral care device described herein.

The first component includes a salt capable of delivering zinc ions. By the term “zinc ion” is meant that the zinc-atom portion of a molecule of the zinc compound in the solid or undissociated state, is capable of being dissociated into simple or complex zinc ions, especially when dispersed in an aqueous medium. Examples of the compounds that may be employed are zinc salts of the following inorganic ions: borate, bromide, carbonate, hexofluorosilicate, pyrophosphate, silicate, sulphate and titanate. Organic anions are those having from 2 to 22 carbon atoms with a charged group selected from carboxylate, sulphonate, sulphate and phosphate. Specific examples include, but are not limited to, acetate, benzoate, citrate, glycinate, lactate, phenolsulphonate, salicylate, tartrate, acetylacetonate, maleate, succinate, ascorbate, and gluconate.

The zinc salts will generally be present in oral care compositions in an amount from about 0.05 to about 10%, preferably between about 0.2 and 5%, optimally between about 0.8 and 3% by weight.

The first component may be a gel and the second composition may be in the form of an opaque paste. The gel will include a peroxygen compound such as hydrogen peroxide, urea peroxide, calcium peroxide and the salts of perborate, persilicate, perphosphate and percarbonate. The amount of the peroxygen compound may range from about 0.1 to about 10% by weight. In terms of active weight hydrogen peroxide, the amount will range from about 0.5 to about 5%, preferably from about 0.8 to about 4%, optimally between about 1 and 3% by weight.

Instead of a peroxygen compound, the first component may contain a C₂-C₂₀ carboxylic acid. Illustrative acids include citric, malic, lactic and ascorbic acids. Levels of the acids may range in amounts similar to that of the peroxygen compound, i.e. from about 0.1 to about 10% by weight. Citric acid is most preferred. When present, these acids will either be in liquid, gel or paste type compositions.

Advantageously, the pH of the first component will be held between about 3.2 and 5.0, preferably from 4.0 to 4.5.

The bicarbonate-containing second component may also contain a fluoride anticaries compound selected from the same fluoride compounds in essentially identical amounts to those described hereinabove with respect to the first composition. Especially preferred is sodium fluoride. Bicarbonate salts will be present in alkali metal form, examples of which are sodium and potassium. Typically, the concentration of bicarbonate salt will range from about 0.5 to about 80%, preferably from about 5 to about 50%, optimally between about 8 and about 20% by weight. The pH of the bicarbonate composition may range from about 7.0 to about 9.5, most preferably about 8.0 to 9.0. When the bicarbonate composition is in toothpaste or gel form, there will typically be included a natural or synthetic thickening agent in an amount from about 0.1 to 10%, preferably about 0.5 to 5% by weight.

Relative weight amounts of the first composition to that of the second composition will range from about 1:2 to 2:1, preferably about 1:1.

Dentifrice Compositions and Components

Oral care compositions and components formulated as a dentifrice generally include a binder, a carrier, and an active ingredient. In some instances, the dentifrice may also include one or more of the following: a surfactant and/or detergent, a thickening agent, a polishing agent, a carrier, a humectant, a salt, etc. Examples of suitable dentifrice ingredients are described below.

Binder

The binder system, generally, is a primary factor that determines the rheological characteristics of the oral care composition. The binder also acts to keep any solid phase of an oral care component suspended, thus preventing separation of the solid phase portion of the oral care component from the liquid phase portion. Additionally, the binder can provide body or thickness to the oral care composition. Thus, in some instances, a binder can also provide a thickening function to an oral care composition.

Examples of binders include sodium carboxymethyl-cellulose, cellulose ether, xanthan gum, carrageenan, sodium alginate, carbopol, or silicates such as hydrous sodium lithium magnesium silicate. Other examples of suitable binders include polymers such as hydroxypropyl methylcellulose, hydroxyethyl cellulose, guar gum, tragacanth gum, karaya gum, arabic gum, Irish moss, starch, and alginate. Alternatively, the binder can include a clay, for example, a synthetic clay such as a hectorite, or a natural clay. Each of the binders can be used alone or in combination with other binders.

Surfactants/Detergents

In some instances, the dentifrice may includes one or more surfactants or detergents to provide a desirable foaming quality.

Surfactants generally include anionic, nonionic, cationic and zwitterionic or amphoteric compositions. Examples of surfactants include soaps, sulfates (e.g., sodium lauryl sulfate and sodium dodecyl benzene sulfonate), sodium lauryl sarcosinate, sorbitan esters of fatty acids, sulfobetaines (e.g., cocamidopropylbatine), and D-glucopyranoside C₁₀₋₁₆ alkyl oligomeric. In some embodiments, the surfactants include sodium lauryl sulphate, cocamidopropyl betaine, and D-glucopyranoside C₁₀-C₁₆ alkyl oligomeric. In general, surfactants are present in an amount from about 0.2 to about 8% by weight (e.g., from about 1 to about 5% or from about 1.5 to about 3.5%).

Thickening Agents

Examples of thickening agents include thickening silica, polymers, clays, and combinations thereof. Thickening silica, for example, SILODENT 15 hydrated silica, in the amount between about 4% to about 8% by weight (e.g., about 6%) provide desirable in-mouth characteristics. The phrase “in-mouth characteritics” as described herein relates to the body and thickness of the dentifrice as it foams in the mouth of a user.

Polishing Agents

Examples of polishing agents include abrasives, such as carbonates (e.g., sodium bicarbonate, calcium carbonate) water-colloidal silica, precipitated silicas (e.g., hydrated silica), sodium aluminosilicates, silica grades containing alumina, hydrated alumina, dicalcium phosphates, insoluble sodium metaphosphate, and magnesiums (e.g., trimagnesium phosphate). A suitable amount of polishing agent is an amount that safely provides good polishing and cleaning and which, when combined with other ingredients gives a smooth, flowable, and not excessively gritty composition. In general, when polishing agents are included, they are present in an amount from about 5% to about 50% by weight (e.g., from about 5% to about 35%, or from about 7% to about 25%).

Carriers

Examples of carriers include water, polyethylene glycol, glycerin, polypropylene glycol, starches, sucrose, alcohols (e.g., methanol, ethanol, isopropanol, etc.), or combinations thereof. Examples of combinations include various water and alcohol combinations and various polyethylene glycol and polypropylene glycol combinations. In general, the amount of carrier included is determined based on the concentration of the binder system along with the amount of dissolved salts, surfactants, and dispersed phase.

Humectants

Generally, humectants are polyols. Examples of humectants include glycerin, sorbitol propyleneglycol, xylitol, lactitol, polypropylene glycol, polyethylene glycol, hydrogenated corn syrup and mixtures thereof. In general, when humectants are included they can be present in an amount from about 10% to about 60% by weight.

Buffers and/or Salts

Examples of buffers and salts include primary, secondary, or tertiary alkali metal phosphates, citric acid, sodium citrate, sodium saccharin, tetrasodium pyrophosphate, sodium hydroxide, and the like.

Active Ingredients

Dentifrices may include active ingredients, for example, to prevent cavities, to whiten teeth, to freshen breath, to deliver oral medication, and to provide other therapeutic and cosmetic benefits such as those described above. Examples of active ingredients include the following: anti-caries agents (e.g., water soluble fluoride salts, fluorosilicates, fluorozirconates, fluorostannites, fluoroborates, fluorotitanates, fluorogermanates, mixed halides and casine); anti-tarter agents; anti-calculus agents (e.g. alkali-metal pyrophosphates, hypophosphite-containing polymers, organic phosphocitrates, phosphocitrates, polyphosphates); anti-bacterial agents (e.g., bacteriocins, antibodies, enzymes); anti-bacterial enhancing agents; anti-microbial agents (e.g., Triclosan, chlorhexidine, copper-, zinc- and stannous salts such as zinc citrate, zinc sulfate, zinc glycinate, sanguinarine extract, metronidazole, quaternary ammonium compounds, such as cetylpyridinium chloride; bis-guanides, such as chlorhexidine digluconate, hexetidine, octenidine, alexidine; and halogenated bisphenolic compounds, such as 2,2′ methylenbis-(4-chloro-6-bromophenol)); desensitizing agents (e.g., potassium citrate, potassium chloride, potassium tartrate, potassium bicarbonate, potassium oxalate, potassium nitrate and strontium salts); whitening agents (e.g., bleaching agents such as peroxy compounds, e.g. potassium peroxydiphosphate); anti-plaque agents; gum protecting agents (e.g., vegetable oils such as sunflower oil, rape seed oil, soybean oil and safflower oil, and other oils such as silicone oils and hydrocarbon oils). The gum protection agent may be an agent capable of improving the permeability barrier of the gums. Other active ingredients include wound healing agents (e.g., urea, allantoin, panthenol, alkali metal thiocyanates, chamomile-based actives and acetylsalicylic acid derivatives, ibuprofen, flurbiprofen, aspirin, indomethacin etc.); tooth buffering agents; demineralization agents; anti-inflammatory agents; anti-malodor agent; breath freshing agents; and agents for the treatment of oral conditions such as gingivitis or periodontitis.

Other Ingredients

In some instances, dentifrices may include effervescing systems such as sodium bicarbonate citric acid systems, or color change systems.

Dentifrices may also include one or more of the following: phenolic compounds (e.g., phenol and its homologues, including 2-methyl-phenol, 3-methyl-phenol. 4-methyl-phenol, 4-ethyl-phenol, 2,4-dimethol-phenol, and 3,4-dimethol-phenol); sweetening agents (e.g., sodium saccharin, sodium cyclamate, sucrose, lactose, maltose, and fructose); flavors (e.g., peppermint oil, spearmint oil, eucalyptus oil, aniseed oil, fennel oil, caraway oil, methyl acetate, cinnamaldehyde, anethol, vanillin, thymol and other natural or nature-identical essential oils or synthetic flavors); preservatives (e.g., p-hydroxybenzoic acid methyl, ethyl, or propyl ester, sodium sorbate, sodium benzoate, bromochlorophene, triclosan, hexetidine, phenyl silicylate, biguanides, and peroxides); opacifying and coloring agents such as titanium dioxide or F D & C dyes; and vitamins such as retinol, tocopherol or ascorbic acid.

Mouth Rinse Compositions and Components

The compositions and components discussed herein may be provided in the form of mouthrinses or mouthwashes.

Ingredients of such mouthwashes and mouthrinses typically include one or more of water (from about 45% to about 95%), ethanol (from about 0% to about 25%), a humectant (from about 0% to about 50%), a surfactant (from about 0.01% to about 7%), a flavoring agent (from about 0.04% to about 2%), a sweetening agent (from about 0.1% to about 3%), and a coloring agent (from about 0.001% to about 0.5%). Such mouthwashes and mouthrinses may also include one or more of an anticaries agent (from about 0.05% to about 0.3% as fluoride ion) and an anticalculus agent (from about 0.1% to about 3%). The compositions and components discussed herein may also be in the form of dental solutions and irrigation fluids. Ingredients of such dental solutions generally include one or more of water (from about 90% to about 99%), preservative (from about 0.01% to about 0.5%), thickening agent (from 0% to about 5%), flavoring agent (from about 0.04% to about 2%), sweetening agent (from about 0.1% to about 3%), and surfactant (from 0% to about 5%). Some examples of rinses that may be used with the present invention are described in U.S. Pat. No. 6,440,395 to Libin; U.S. Pat. No. 6,355,229 to Adamy; U.S. Pat. No. 6,344,184 to Rolla; U.S. Pat. No. 6,117,417 to Wicks et al.; U.S. Pat. No. 5,980,925 to Jampani et al.; U.S. Pat. No. 5,948,390 to Nelson et al.; U.S. Pat. No. 5,686,063 and U.S. Pat. No. 5,681,549 both to McLaughlin et al.; U.S. Pat. No. 5,626,837 to Shimada, et al.; U.S. Pat. No. 5,560,906 to Scodari et al.; U.S. Pat. No. 5,407,664 and U.S. Pat. No. 5,292,527 both to Konopa; U.S. Pat. No. 5,405,604 to Hall; U.S. Pat. No. 5,374,418 and U.S. Pat. No. 5,370,865 both to Yamagishi et al., U.S. Pat. No. 5,286,479 to Garlich et al.; U.S. Pat. Nos. 5,525,330; 5,256,396; 5,158,763; 4,370,314; 4,339,430; 4,273,759; 4,224,309; 4,188,372; 4,137,303; 4,123,512; 4,118,476; 4,118,475; 4,118,474; 4,118,473; 4,118,472; 4,110,429; 4,102,993; 4,100,270; 4,089,880; 4,080,441; 4,042,679; and 3,864,472 and WO 03/075865 (all assigned to Colgate Palmolive); U.S. Pat. No. 4,994,262 to Charbonneau et al.; U.S. Pat. Nos. 4,959,204; 4,663,154 and 4,472,373 all to Ryan; U.S. Pat. No. 4 4,325,939 to Shah; U.S. Pat. No. 4,323,551, to Parran, Jr.; WO 96/15770, WO 94/27566 and WO 94/18939; WO 00/44338; U.S. 2006/0171907A1; U.S. Pat. No. 7,195,753; U.S. Pat. No. 7,192,573; U.S. Pat. No. 7,153,493; U.S. Pat. No. 6,696,047; U.S. Pat. No. 6,361,762; U.S. Pat. No. 6,350,438; U.S. Pat. No. 6,348,187; U.S. Pat. No. 6,261,540; U.S. Pat. No. 6,251,372; U.S. Pat. No. 5,707,610; U.S. Pat. No. 5,681,548; U.S. Pat. No. 5,945,088; U.S. Pat. No. 5,945,087; U.S. Pat. No. 5,723,106; U.S. Pat. No. 5,338,538; U.S. Pat. No. 5,330,749; U.S. Pat. No. 5,310,546; U.S. Pat. No. 5,302,373; U.S. Pat. No. 5,236,699; U.S. Pat. No. 5,229,103; U.S. Pat. No. 5,256,401; U.S. Pat. No. 5,174,990; U.S. Pat. No. 5,104,644; U.S. Pat. No. 5,087,444; U.S. Pat. No. 5,043,183; U.S. Pat. No. 4,894,220; U.S. Pat. No. 4,684,517; and U.S. Pat. No. 4,537,778.

Some non-limiting examples of a first component/composition and a second component/composition, which can be either simultaneously or sequentially (i.e., the second component following the first component) delivered by wide variety of devices and/or packages, some of which have been described herein, are set forth in Table 1 below. The first and second components of Table 1 can be delivered using any of the regimens, dosages, steps, or methods, in whole or part, described herein and may be provided in variety of forms, including but not limited to a dentifrice, rinse, gel, liquid, or paste.

TABLE 1

| | First Component | Second Component |
|---|---|---|
| 1 | A stannous salt, such as stannous | A peroxide source, such as hydrogen |
| | chloride, stannous fluoride, stannous | peroxide or its precursors, and |
| | lactate, stannous gluconate, and | combinations thereof. |
| | combinations thereof. | |
| 2 | A stannous salt, such as stannous | A chlorite source, such as sodium |
| | chloride, stannous fluoride, stannous | chlorite, calcium chlorite, barium |
| | lactate, stannous gluconate, and | chlorite, magnesium chlorite, lithium |
| | combinations thereof. | chlorite, sodium chlorite, potassium |
| | | chlorite, and combinations thereof. |
| 3 | A calcium salt, such as calcium | A phosphate, such as phosphoric acid, |
| | fluoride, calcium chloride, calcium | or salts of phosphoric acid containing |
| | nitrate, calcium sulfate, calcium | the PO₄ ion, as such acids or acid salts |
| | acetate, calcium gluconate, and | thereof, such as sodium phosphate |
| | combinations thereof. | monobasic, sodium phosphate dibasic, |
| | | sodium phosphate tribasic, and |
| | | combinations thereof. |
| 4 | A stannous salt, such stannous | An abrasive, such as carbonates (e.g., |
| | chloride, stannous fluoride, stannous | sodium bicarbonate, calcium carbonate) |
| | lactate, and stannous gluconate; | water-colloidal silica, precipitated |
| | and/or/optionally with a quaternary | silicas (e.g., hydrated silica), sodium |
| | ammonium compound, such as | aluminosilicates, silica grades |
| | cetylpyridinium chloride; bis- | containing alumina, hydrated alumina, |
| | guanides, such as chlorhexidine | dicalcium phosphates, insoluble sodium |
| | digluconate, hexetidine, octenidine, | metaphosphate, and magnesiums (e.g., |
| | alexidine; and halogenated | trimagnesium phosphate); |
| | bisphenolic compounds, such as 2,2′ | and/or/optionally in combination with a |
| | methylenbis-(4-chloro-6- | surfactant (e.g., anionic, nonionic, |
| | bromophenol)); and/or/optionally in | cationic and zwitterionic or amphoteric |
| | combination with a flavor, such as | compositions), such as soaps, sulfates |
| | peppermint oil, spearmint oil, | (e.g., sodium lauryl sulfate and sodium |
| | eucalyptus oil, aniseed oil, fennel oil, | dodecyl benzene sulfonate), sodium |
| | caraway oil, methyl acetate, | lauryl sarcosinate, sorbitan esters of |
| | cinnamaldehyde, anethol, vanillin, | fatty acids, sulfobetaines (e.g., |
| | thymol and other natural or nature- | cocamidopropylbatine), and D- |
| | identical essential oils or synthetic | glucopyranoside C₁₀₋₁₆ alkyl |
| | flavors; and combinations of the | oligomeric; and combinations of the |
| | foregoing | foregoing. |
| 5 | A phosphate, such as phosphoric | A calcium salt, such as calcium |
| | acid, or salts of phosphoric acid | fluoride, calcium chloride, calcium |
| | containing the PO₄ ion, as such acids | nitrate, calcium sulfate, calcium |
| | or acid salts thereof, such as sodium | acetate, calcium gluconate, and |
| | phosphate monobasic, sodium | combinations thereof. |
| | phosphate dibasic, sodium phosphate | |
| | tribasic, and combinations thereof. | |
| 6 | A fluoride source, such as sodium | Any composition with a pH greater |
| | fluoride, zinc fluoride, betaine | than about 7. |
| | fluoride, alanine stannous fluoride, | |
| | hexylamine fluoride, at a pH between | |
| | about 2 and about 6, and | |
| | combinations thereof | |
| 7 | A first flavor, such as peppermint oil, | A second flavor, such as peppermint |
| | spearmint oil, eucalyptus oil, aniseed | oil, spearmint oil, eucalyptus oil, |
| | oil, fennel oil, caraway oil, methyl | aniseed oil, fennel oil, caraway oil, |
| | acetate, cinnamaldehyde, anethol, | methyl acetate, cinnamaldehyde, |
| | vanillin, thymol and other natural or | anethol, vanillin, thymol and other |
| | nature-identical essential oils or | natural or nature-identical essential oils |
| | synthetic flavors, and combinations | or synthetic flavors, and combinations |
| | thereof. | thereof. |
| 8 | A quaternary ammonium compound, | A peroxide source, such as hydrogen |
| | such as cetylpyridinium chloride; bis- | peroxide or its precursors, and |
| | guanides, such as chlorhexidine | combinations thereof. |
| | digluconate, hexetidine, octenidine, | |
| | alexidine; and halogenated | |
| | bisphenolic compounds, such as 2,2′ | |
| | methylenbis-(4-chloro-6- | |
| | bromophenol)); and combinations | |
| | thereof. | |
| 9 | A flavor, such as peppermint oil, | A peroxide source, such as hydrogen |
| | spearmint oil, eucalyptus oil, aniseed | peroxide or its precursors, and |
| | oil, fennel oil, caraway oil, methyl | combinations thereof. |
| | acetate, cinnamaldehyde, anethol, | |
| | vanillin, thymol and other natural or | |
| | nature-identical essential oils or | |
| | synthetic flavors, and combinations | |
| | thereof. | |
| 10 | A quaternary ammonium compound, | A chlorite source, such as sodium |
| | such as cetylpyridinium chloride; bis- | chlorite, calcium chlorite, barium |
| | guanides, such as chlorhexidine | chlorite, magnesium chlorite, lithium |
| | digluconate, hexetidine, octenidine, | chlorite, sodium chlorite, potassium |
| | alexidine; and halogenated | chlorite, and combinations thereof. |
| | bisphenolic compounds, such as 2,2′ | |
| | methylenbis-(4-chloro-6- | |
| | bromophenol)); and combinations | |
| | thereof. | |
| 11 | A flavor, such as peppermint oil, | A chlorite source, such as sodium |
| | spearmint oil, eucalyptus oil, aniseed | chlorite, calcium chlorite, barium |
| | oil, fennel oil, caraway oil, methyl | chlorite, magnesium chlorite, lithium |
| | acetate, cinnamaldehyde, anethol, | chlorite, sodium chlorite, potassium |
| | vanillin, thymol and other natural or | chlorite, and combinations thereof. |
| | nature-identical essential oils or | |
| | synthetic flavors, and combinations | |
| | thereof. | |
| 12 | A calcium salt, such as calcium | A fluoride source, such as sodium |
| | fluoride, calcium chloride, calcium | fluoride, zinc fluoride, betaine fluoride, |
| | nitrate, calcium sulfate, calcium | alanine stannous fluoride, hexylamine |
| | acetate, calcium gluconate, and | fluoride, and combinations thereof. |
| | combinations thereof. | |
| 13 | A fluoride source, such as sodium | A calcium salt, such as calcium |
| | fluoride, zinc fluoride, betaine | fluoride, calcium chloride, calcium |
| | fluoride, alanine stannous fluoride, | nitrate, calcium sulfate, calcium |
| | hexylamine fluoride, and | acetate, calcium gluconate, and |
| | combinations thereof. | combinations thereof. |
| 14 | A disclosing agent, such as | An abrasive, such as carbonates (e.g., |
| | fluoroscein, dibromofluoroscein, | sodium bicarbonate, calcium carbonate) |
| | tribromofluoroscein, | water-colloidal silica, precipitated |
| | tetrabromofluoroscein, other | silicas (e.g., hydrated silica), sodium |
| | fluorescein derivatives (including | aluminosilicates, silica grades |
| | salts thereof), xanthenes, pyrenes, | containing alumina, hydrated alumina, |
| | e.g. pyranine, D&C Blue No. 1, D&C | dicalcium phosphates, insoluble sodium |
| | Blue No. 2, D&C Green No. 3, D&C | metaphosphate, and magnesiums (e.g., |
| | Red No. 3, D&C Red No. 6, D&C | trimagnesium phosphate); |
| | Red No. 7, D&C Red No. 21, D&C | and/or/optionally in combination with a |
| | Red No. 22, D&C Red No. 27, D&C | surfactant (e.g., anionic, nonionic, |
| | Red No. 28, D&C Red No. 33, D&C | cationic and zwitterionic or amphoteric |
| | Red No. 40, D&C Yellow No. 5, | compositions), such as soaps, sulfates |
| | D&C Yellow No. 6, D&C Yellow | (e.g., sodium lauryl sulfate and sodium |
| | No. 10, combinations thereof or any | dodecyl benzene sulfonate), sodium |
| | other dye approved for use in drugs | lauryl sarcosinate, sorbitan esters of |
| | and cosmetics by regulatory agencies, | fatty acids, sulfobetaines (e.g., |
| | and combinations thereof. | cocamidopropylbatine), and D- |
| | | glucopyranoside C₁₀₋₁₆ alkyl |
| | | oligomeric, and combinations of the |
| | | foregoing. |
| 15 | An abrasive, such as carbonates (e.g., | A disclosing agent, such as fluoroscein, |
| | sodium bicarbonate, calcium | dibromofluoroscein, |
| | carbonate) water-colloidal silica, | tribromofluoroscein, |
| | precipitated silicas (e.g., hydrated | tetrabromofluoroscein, other |
| | silica), sodium aluminosilicates, | fluorescein derivatives (including salts |
| | silica grades containing alumina, | thereof), xanthenes, pyrenes, e.g. |
| | hydrated alumina, dicalcium | pyranine, D&C Blue No. 1, D&C Blue |
| | phosphates, insoluble sodium | No. 2, D&C Green No. 3, D&C Red |
| | metaphosphate, and magnesiums | No. 3, D&C Red No. 6, D&C Red No. |
| | (e.g., trimagnesium phosphate); | 7, D&C Red No. 21, D&C Red No. 22, |
| | and/or/optionally in combination with | D&C Red No. 27, D&C Red No. 28, |
| | a surfactant (e.g., anionic, nonionic, | D&C Red No. 33, D&C Red No. 40, |
| | cationic and zwitterionic or | D&C Yellow No. 5, D&C Yellow No. |
| | amphoteric compositions), such as | 6, D&C Yellow No. 10, combinations |
| | soaps, sulfates (e.g., sodium lauryl | thereof or any other dye approved for |
| | sulfate and sodium dodecyl benzene | use in drugs and cosmetics by |
| | sulfonate), sodium lauryl sarcosinate, | regulatory agencies, and combinations |
| | sorbitan esters of fatty acids, | thereof. |
| | sulfobetaines (e.g., | |
| | cocamidopropylbatine), and D- | |
| | glucopyranoside C₁₀₋₁₆ alkyl | |
| | oligomeric; and combinations of the | |
| | foregoing. | |
| 16 | A calcium salt, such as calcium | A phosphate, such as phosphoric acid, |
| | fluoride, calcium chloride, calcium | or salts of phosphoric acid containing |
| | nitrate, calcium sulfate, calcium | the PO₄ ion, as such acids or acid salts |
| | acetate, calcium gluconate, and | thereof, such as sodium phosphate |
| | combinations thereof. | monobasic, sodium phosphate dibasic, |
| | | and sodium phosphate tribasic; in |
| | | combination with a fluoride source, |
| | | such as sodium fluoride, zinc fluoride, |
| | | betaine fluoride, alanine stannous |
| | | fluoride, hexylamine fluoride; and |
| | | combinations of the foregoing. |
| 17 | A zinc salt, such as zinc nitrate, zinc | A peroxide source, such as hydrogen |
| | citrate, zinc chloride, zinc sulfate, | peroxide or its precursors, and |
| | zinc bicarbonate, zinc oxalate, zinc | combinations thereof. |
| | fluoride, zinc lactate, zinc gluconate, | |
| | and combinations thereof. | |
| 18 | A zinc salt, such as zinc nitrate, zinc | A chlorite source, such as sodium |
| | citrate, zinc chloride, zinc sulfate, | chlorite, calcium chlorite, barium |
| | zinc bicarbonate, zinc oxalate, zinc | chlorite, magnesium chlorite, lithium |
| | fluoride, zinc lactate, zinc gluconate, | chlorite, sodium chlorite, potassium |
| | and combinations of the foregoing. | chlorite, and combinations of the |
| | | foregoing. |
| 19 | A copper salt, such as copper | A chlorite source, such as sodium |
| | gluconate, copper chlorate, copper | chlorite, calcium chlorite, barium |
| | chloride, copper fluoride, copper | chlorite, magnesium chlorite, lithium |
| | nitrate, and combinations of thereof. | chlorite, sodium chlorite, potassium |
| | | chlorite, and combinations thereof. |
| 20 | A copper salt, such as copper | A peroxide source, such as hydrogen |
| | gluconate, copper chlorate, copper | peroxide or its precursors, and |
| | chloride, copper fluoride, copper | combinations thereof. |
| | nitrate, and combinations thereof. | |
| 21 | A peroxide source, such as hydrogen | A metal catalyst, such as iron, copper, |
| | peroxide and its precursors, and | manganese, and molybdate, and |
| | combinations thereof. | combinations thereof. |
| 22 | A metal catalyst, such as iron, | A peroxide source, such as hydrogen |
| | copper, manganese, and molybdate, | peroxide or its precursors, and |
| | and combinations thereof. | combinations thereof. |
| 23 | A stannous salt, such as stannous | A pyrophosphate salt, such as dialkali |
| | chloride, stannous fluoride, stannous | or tetraalkali metal pyrophosphate salts |
| | lactate, stannous gluconate, and | such as Na₄P₂O₇(TSPP), K₄P₂O_{7,} |
| | combinations thereof. | Na₂K₂P₂O₇, Na₂H₂P₂O₇ and K₂H₂P₂O₇, |
| | | and wherein the polyphosphate salt |
| | | may include the water soluble alkali |
| | | metal tripolyphosphates such as sodium |
| | | tripolyphosphate and potassium |
| | | tripolyphosphate; and/or/optionally in |
| | | combination with a polyphosphate, |
| | | such as sodium hexametaphosphate or |
| | | any polyphosphate (PO₄)ₙ, where n is 2 |
| | | to 40; and combinations of the |
| | | foregoing. |
| 24 | A pyrophosphate salt, such as dialkali | A stannous salt, such as stannous |
| | or tetraalkali metal pyrophosphate | chloride, stannous fluoride, stannous |
| | salts such as Na₄P₂O₇(TSPP), | lactate, stannous gluconate, and |
| | K₄P₂O₇, Na₂K₂P₂O₇, Na₂H₂P₂O₇ and | combinations thereof. |
| | K₂H₂P₂O₇, and wherein the | |
| | polyphosphate salt may include the | |
| | water soluble alkali metal | |
| | tripolyphosphates such as sodium | |
| | tripolyphosphate and potassium | |
| | tripolyphosphate; and/or/optionally in | |
| | combination with a polyphosphate, | |
| | such as sodium hexametaphosphate | |
| | or any polyphosphate (PO₄)ₙ, where n | |
| | is 2 to 40; and combinations of the | |
| | foregoing. | |
| 25 | A zinc salt, such as zinc nitrate, zinc | A pyrophosphate salt, such as dialkali |
| | citrate, zinc chloride, zinc sulfate, | or tetraalkali metal pyrophosphate salts |
| | zinc bicarbonate, zinc oxalate, zinc | such as Na₄P₂O₇(TSPP), K₄P₂O₇, |
| | fluoride, zinc lactate, zinc gluconate, | Na₂K₂P₂O₇, Na₂H₂P₂O₇ and K₂H₂P₂O₇. |
| | and combinations thereof. | and wherein the polyphosphate salt |
| | | may include the water soluble alkali |
| | | metal tripolyphosphates such as sodium |
| | | tripolyphosphate and potassium |
| | | tripolyphosphate; and/or/optionally in |
| | | combination with a polyphosphate, |
| | | such as sodium hexametaphosphate or |
| | | any polyphosphate (PO₄)ₙ, where n is 2 |
| | | to 40; and combinations of the |
| | | foregoing. |
| 26 | A pyrophosphate salt, such as dialkali | A zinc salt, such as zinc nitrate, zinc |
| | or tetraalkali metal pyrophosphate | citrate, zinc chloride, zinc sulfate, zinc |
| | salts such as Na₄P₂O₇(TSPP), | bicarbonate, zinc oxalate, zinc fluoride, |
| | K₄P₂O₇, Na₂K₂P₂O₇, Na₂H₂P₂O₇ and | zinc lactate, zinc gluconate, and |
| | K₂H₂P₂O₇, and wherein the | combinations thereof. |
| | polyphosphate salt may include the | |
| | water soluble alkali metal | |
| | tripolyphosphates such as sodium | |
| | tripolyphosphate and potassium | |
| | tripolyphosphate; and/or/optionally in | |
| | combination with a polyphosphate, | |
| | such as sodium hexametaphosphate | |
| | or any polyphosphate (PO₄)ₙ, where n | |
| | is 2 to 40; and combinations of the | |
| | foregoing. | |
| 27 | A copper salt, such as copper | A pyrophosphate salt, such as dialkali |
| | gluconate, copper chlorate, copper | or tetraalkali metal pyrophosphate salts |
| | chloride, copper fluoride, copper | such as Na₄P₂O₇(TSPP), K₄P₂O₇, |
| | nitrate, and combinations thereof. | Na₂K₂P₂O₇, Na₂H₂P₂O₇ and K₂H₂P₂O₇, |
| | | and wherein the polyphosphate salt |
| | | may include the water soluble alkali |
| | | metal tripolyphosphates such as sodium |
| | | tripolyphosphate and potassium |
| | | tripolyphosphate; and/or/optionally in |
| | | combination with a polyphosphate, |
| | | such as sodium hexametaphosphate or |
| | | any polyphosphate (PO₄)ₙ, where n is 2 |
| | | to 40; and combinations of the |
| | | foregoing. |
| 28 | A pyrophosphate salt, such as dialkali | A copper salt, such as copper |
| | or tetraalkali metal pyrophosphate | gluconate, copper chlorate, copper |
| | salts such as Na₄P₂O₇(TSPP), | chloride, copper fluoride, copper |
| | K₄P₂O₇, Na₂K₂P₂O₇, Na₂H₂P₂O₇ and | nitrate, and combinations thereof. |
| | K₂H₂P₂O₇, and wherein the | |
| | polyphosphate salt may include the | |
| | water soluble alkali metal | |
| | tripolyphosphates such as sodium | |
| | tripolyphosphate and potassium | |
| | tripolyphosphate; and/or/optionally in | |
| | combination with a polyphosphate, | |
| | such as sodium hexametaphosphate | |
| | or any polyphosphate (PO₄)ₙ, where n | |
| | is 2 to 40; and combinations of the | |
| | foregoing. | |
| 29 | A metal salt, such as stannous, | A pyrophosphate salt, such as dialkali |
| | copper, zinc, silver, tin, manganese, | or tetraalkali metal pyrophosphate salts |
| | iron, magnesium, and combinations | such as Na₄P₂O₇(TSPP), K₄P₂O₇, |
| | thereof. | Na₂K₂P₂O₇, Na₂H₂P₂O₇ and K₂H₂P₂O₇, |
| | | and wherein the polyphosphate salt |
| | | may include the water soluble alkali |
| | | metal tripolyphosphates such as sodium |
| | | tripolyphosphate and potassium |
| | | tripolyphosphate; and/or/optionally in |
| | | combination with a polyphosphate, |
| | | such as sodium hexametaphosphate or |
| | | any polyphosphate (PO₄)ₙ, where n is 2 |
| | | to 40; and combinations of the |
| | | foregoing. |
| 30 | A pyrophosphate salt, such as dialkali | A metal salt, such as stannous, copper, |
| | or tetraalkali metal pyrophosphate | zinc, silver, tin, manganese, iron, |
| | salts such as Na₄P₂O₇(TSPP), | magnesium and combinations thereof |
| | K₄P₂O₇, Na₂K₂P₂O₇, Na₂H₂P₂O₇ and | |
| | K₂H₂P₂O₇, and wherein the | |
| | polyphosphate salt may include the | |
| | water soluble alkali metal | |
| | tripolyphosphates such as sodium | |
| | tripolyphosphate and potassium | |
| | tripolyphosphate; and/or/optionally in | |
| | combination with a polyphosphate, | |
| | such as sodium hexametaphosphate | |
| | or any polyphosphate (PO₄)ₙ, where n | |
| | is 2 to 40; and combinations of the | |
| | foregoing. | |
| 31 | A metal salt, such as stannous, | An oxidizer, such as chlorite salts, |
| | copper, zinc, silver, tin, manganese, | hydrogen peroxide (or a peroxide |
| | iron, magnesium and combinations | source), perborates, perchlorates, |
| | thereof | hyperchlorates, and combinations |
| | | thereof. |
| 32 | An anti-bacterial agent, such as | A polyphosphate, such as sodium |
| | triclosan (2,4,4-trichloro-2′-hydroxy- | hexametaphosphate or any |
| | diphenyl ether), chlorhexidine, | polyphosphate (PO₄)ₙ, where n is 2 to |
| | copper-, zinc- and stannous salts such | 40; and/or/optionally with an oxidizer, |
| | as zinc citrate, zinc sulfate, zinc | such as chlorite salts, hydrogen |
| | glycinate, sanguinarine extract, | peroxide, perborates, perchlorates, and |
| | metronidazole, quaternary | hyperchlorates; and/or/optionally with a |
| | ammonium compounds, such as | chelant, such as alkali metal stannates |
| | cetylpyridinium chloride; bis- | such as sodium and potassium stannate, |
| | guanides, such as chlorhexidine | ethylenediaminetetracetic acid (EDTA) |
| | digluconate, hexetidine, octenidine, | and its salts, citrate, and malate and |
| | alexidine; and halogenated | salts and acids thereof; and |
| | bisphenolic compounds, such as 2,2′ | combinations of the foregoing. |
| | methylenbis-(4-chloro-6- | |
| | bromophenol)), and combinations | |
| | thereof. | |
| 33 | A disclosing agent, such as | A polyphosphate, such as sodium |
| | fluoroscein, dibromofluoroscein, | hexametaphosphate or any |
| | tribromofluoroscein, | polyphosphate (PO₄)ₙ, where n is 2 to |
| | tetrabromofluoroscein, other | 40; and/or/optionally with an oxidizer, |
| | fluorescein derivatives (including | such as chlorite salts, hydrogen |
| | salts thereof), xanthenes, pyrenes, | peroxide, perborates, perchlorates, and |
| | e.g. pyranine, D&C Blue No. 1, D&C | hyperchlorates; and/or/optionally with a |
| | Blue No. 2, D&C Green No. 3, D&C | chelant, such as alkali metal stannates |
| | Red No. 3, D&C Red No. 6, D&C | such as sodium and potassium stannate, |
| | Red No. 7, D&C Red No. 21, D&C | ethylenediaminetetracetic acid (EDTA) |
| | Red No. 22, D&C Red No. 27, D&C | and its salts, citrate, and malate and |
| | Red No. 28, D&C Red No. 33, D&C | salts and acids thereof; and |
| | Red No. 40, D&C Yellow No. 5, | combinations of the foregoing. |
| | D&C Yellow No. 6, D&C Yellow | |
| | No. 10, combinations thereof or any | |
| | other dye approved for use in drugs | |
| | and cosmetics by regulatory agencies, | |
| | and combinations thereof. | |
| 34. | A stannous salt, such as stannous | A quaternary ammonium compound, |
| | chloride, stannous fluoride, stannous | such as cetylpyridinium chloride; bis- |
| | lactate, stannous gluconate, and | guanides, such as chlorhexidine |
| | combinations thereof. | digluconate, hexetidine, octenidine, |
| | | alexidine; and halogenated bisphenolic |
| | | compounds, such as 2,2′ methylenbis- |
| | | (4-chloro-6-bromophenol)); and |
| | | combinations thereof; in combination |
| | | with a peroxide source, such as |
| | | hydrogen peroxide or its precursors, |
| | | and combinations thereof. |

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

All documents cited in the Detailed Description are incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

What is claimed is:

1. An oral care method using a display and a toothbrush having a handle, a head, a liquid reservoir in fluid communication with an outlet, and a pump, comprising:
dispensing an oral care composition from a package onto the head of the toothbrush;
using the toothbrush to apply the oral care composition to an oral cavity; and
wherein the display provides a signal to a user to dispense a liquid from the liquid reservoir of the toothbrush through the outlet.

2. The method of claim 1, wherein the signal is an audio signal, a visual signal, or a combination thereof.

3. The method of claim 1, wherein the toothbrush further comprises a data communicator that is in data communication with the display.

4. The method of claim 3, wherein the data communicator is a radio frequency tag.

5. The method of claim 4, wherein the oral care composition is a dentifrice that is stored in a dentifrice package.

6. The method of claim 5, further comprising dispensing the liquid into the liquid reservoir from a liquid package.

7. The method of claim 6, wherein the dentifrice package and the liquid package each further comprise a data communicator.

8. The method of claim 7, wherein the data communicators of the dentifrice package and the liquid package are radio frequency tags.

9. The method of claim 8, further comprising placing the toothbrush, dentifrice package, and rinse package near the display so that the data communicators can communicate with the display.

10. The method of claim 1, wherein the pump pressurizes the liquid reservoir.

11. The method of claim 1, wherein the pump pumps the liquid from the liquid reservoir to the outlet.

12. The method of claim 1, wherein the display displays a time interval for use of the dentifrice in the oral cavity.

13. The method of claim 12, wherein the time interval for use of the dentifrice in the oral cavity is between about 1 and about 3 minutes.

14. The method of claim 13, wherein the display displays a time interval for use of the liquid in the oral cavity.

15. The method of claim 14, wherein the time interval for use of the liquid in the oral cavity is between about 20 seconds and about 2 minutes.

16. An oral care method using a display, a toothbrush, and a package comprising a first compartment and a second compartment, the first compartment having a first composition the second compartment having a second composition, comprising:
dispensing the first composition from the package onto a head of the toothbrush;
using the toothbrush to apply the first composition to an oral cavity;
wherein the display provides a signal to a user to dispense the second composition from the package onto the head of the toothbrush; and
using the toothbrush to apply the second composition to the oral cavity.

17. The method of claim 16, wherein the signal is an audio signal, a visual signal, or a combination thereof.

18. The method of claim 16, wherein the toothbrush further comprises a data communicator that is in data communication with the display.

19. The method of claim 18, wherein the data communicator is a radio frequency tag.

20. The method of claim 19, wherein the package comprises a data communicator.

21. The method of claim 20, wherein the data communicator of the package is a radio frequency tag.

22. The method of claim 21, further comprising placing the toothbrush and the package near the display so that the data communicators can communicate with the display.

23. The method of claim 16, wherein the display displays a time interval for use of the first composition in the oral cavity.

24. The method of claim 23, wherein the time interval for use of the first composition in the oral cavity is between about 30 seconds and about 3 minutes.

25. The method of claim 23, wherein the display displays a time interval for use of the second composition in the oral cavity.

26. The method of claim 25, wherein the time interval for use of the second composition in the oral cavity is between about 30 seconds and about 2 minutes.

27. The method of claim 25, wherein the time interval for use of the second composition is displayed after the time interval for use of the first composition.

28. A kit, comprising:
a dentifrice package having a data communicator;
a liquid package having a data communicator;
a toothbrush having a liquid reservoir and a data communicator; and
a display capable of data communication with the data communicators.
